(19) United States
(12) Patent Application Publication
(10) Pub. No.: US 2025/0317927 A1
(43) Pub. Date: Oct. 9, 2025

(54) BSR BASED ON TRAFFIC ESTIMATION

(71) Applicant: QUALCOMM Incorporated, San Diego, CA (US)

(72) Inventors: Mickael MONDET, Louannec (FR); Yann LEBRUN, Velizy-Villacoublay (FR); Ovidiu Constantin IACOBOAIEA, Chatillon (FR); Archit YADAV, Cambridge (GB); Ravi AGARWAL, San Diego, CA (US); Chih-Ping LI, San Diego, CA (US); Zhichao ZHOU, Beijing (CN); Hyun Yong LEE, San Diego, CA (US); Peerapol TINNAKORNSRISUPHAP, San Diego, CA (US)

(21) Appl. No.: 18/862,916

(22) PCT Filed: Jul. 19, 2022
(86) PCT No.: PCT/CN2022/106405

§ 371 Date: Nov. 4, 2024

(51) Int. Cl. H04W 72/1268; H04W 72/52

(52) U.S. Cl. CPC H04W 72/1268; H04W 72/52

(57) ABSTRACT

A UE may obtain an estimation of a second SDU based on at least one first SDU with a first arrival time at a modem of the UE, the estimation of the second SDU including a second arrival time at the modem of the UE, the second arrival time being after the first arrival time, and initiate a transmission of a second BSR of the second SDU based on the estimation of the second SDU. The network node may receive at least one BSR indicating at least one target PUSCH from the UE, transmit at least one uplink grant of the at least one target PUSCH based on the at least one BSR indicating the at least one target PUSCH, and receive the second SDU in the at least one target PUSCH.

### TECHNICAL FIELD

The present disclosure relates generally to communication systems, and more particularly, to a method of wireless communication including a buffer status report (BSR) based on traffic estimation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment, and the user equipment (UE) may obtain an estimation of a second service data unit (SDU) based on at least one first SDU with a first arrival time at a modem of the UE, the estimation of the second SDU including a second arrival time at the modem of the UE, the second arrival time being after the first arrival time, and initiate a transmission of a second buffer status report (BSR) of the second SDU based on the estimation of the second SDU.

in an aspect of the disclosure, a method, a computer-readable medium, and an apparatus may include a network node configured to receive at least one BSR indicating at least one target PUSCH from a UE, the at least one BSR including a second BSR based on an estimation of a second SDU including a second arrival time of the second SDU at a modem of the UE, the estimation of the second SDU being based on at least one first SDU with a first arrival time at the modem of the UE, the second arrival time being after the first arrival time, transmit at least one uplink grant of the at least one target PUSCH based on the at least one BSR indicating the at least one target PUSCH, and receive the second SDU in the at least one target PUSCH.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram of a method of wireless communication including a buffer status report (BSR).

FIG. 5 is a diagram of a method of wireless communication including the BSR.

FIG. 6 is a diagram of a method of wireless communication including the BSR.

FIG. 7 is a diagram of a method of wireless communication including the BSR.

FIG. 8 is a diagram of a method of wireless communication including the BSR.

FIG. 9 is a diagram of a method of wireless communication including the BSR.

FIG. 10 is a diagram of a method of wireless communication including the BSR.

FIG. 11 is a diagram of a method of wireless communication including the BSR.

FIG. 12 is a diagram of a method of wireless communication including the BSR.

FIG. 13 is a diagram of a method of wireless communication including the BSR.

FIG. 14 is a call-flow diagram of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

### DETAILED DESCRIPTION

A user equipment may include at least one application and a modem. A service data unit (SDU) from the at least one application may arrive at an empty buffer of the modem, and the UE may initiate the transmission of a buffer status report (BSR). To transmit the BSR, the UE may send a scheduling request (SR), receive the UL grant, and transmit the BSR. Based on some aspects of the current disclosure to reduce the signaling overhead and reduce the latency, the UE may estimate or predict the arrival time and size of future SDU.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

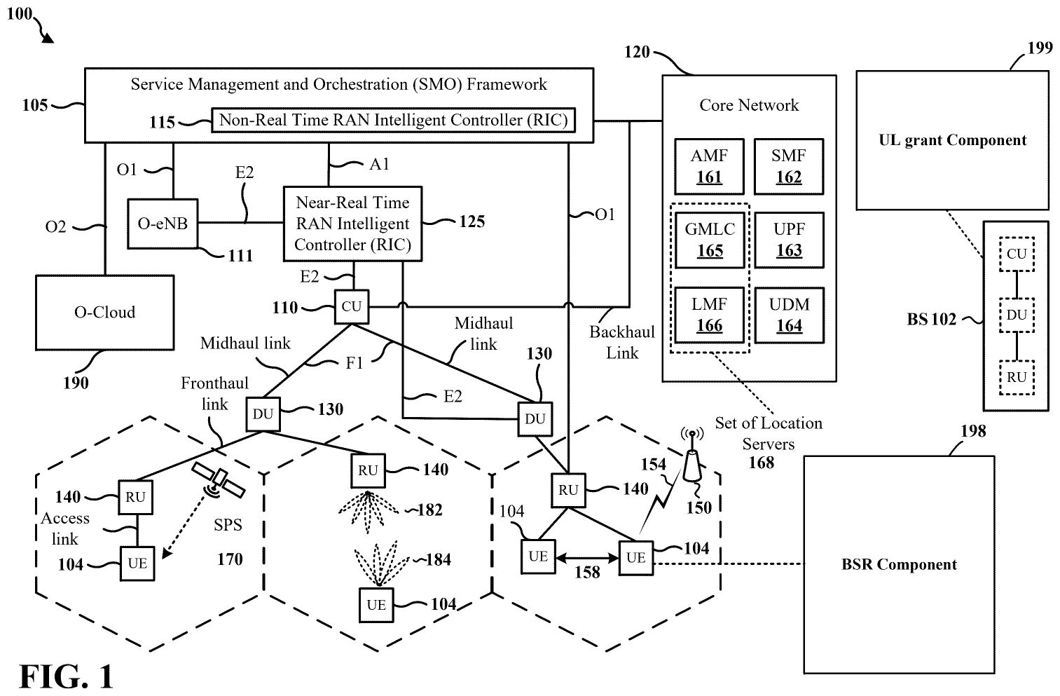

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a BSR component 198 configured to obtain an estimation of a second SDU based on at least one first SDU with a first arrival time at a modem of the UE, the estimation of the second SDU including a second arrival time at the modem of the UE, the second arrival time being after the first arrival time, and initiate a transmission of a second BSR of the second SDU based on the estimation of the second SDU. In certain aspects, the base station 102 may include a UL grant component 199 configured to receive at least one BSR indicating at least one target PUSCH from a UE, the at least one BSR including a second BSR based on an estimation of a second SDU including a second arrival time of the second SDU at a modem of the UE, the estimation of the second SDU being based on at least one first SDU with a first arrival time at the modem of the UE, the second arrival time being after the first arrival time, transmit at least one uplink grant of the at least one target PUSCH based on the at least one BSR indicating the at least one target PUSCH, and receive the second SDU in the at least one target PUSCH. Although the following description may be focused on 5G NR, the concepts described herein may be applicable to other similar areas, such as LTE, LTE-A, CDMA, GSM, and other wireless technologies.

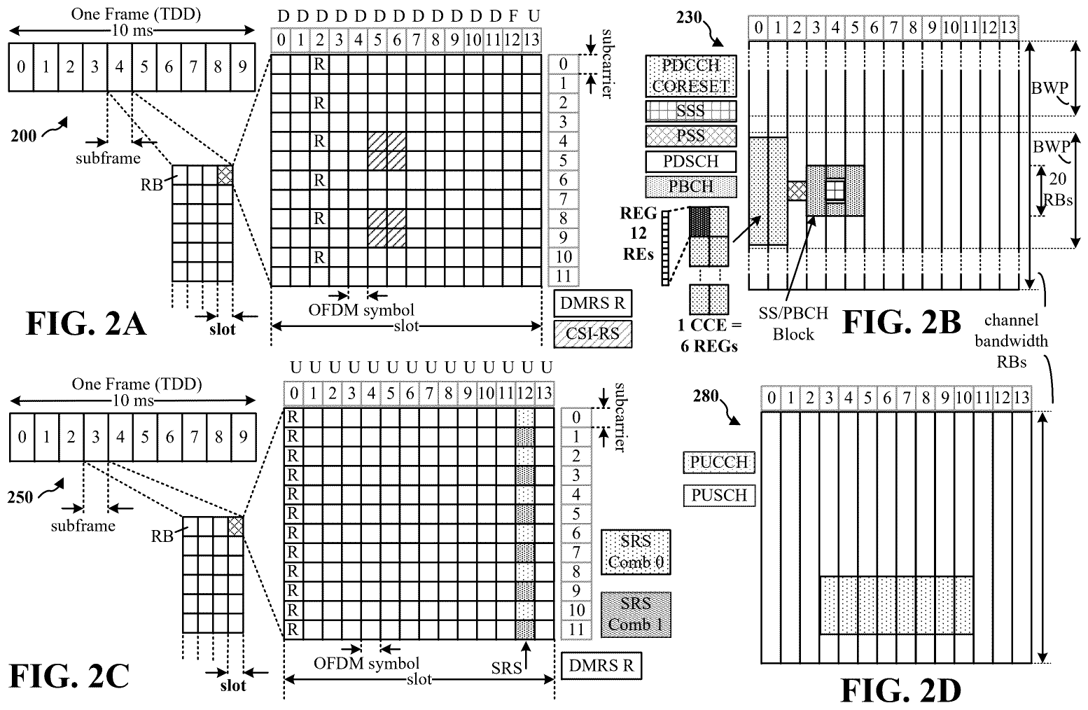

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[KHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

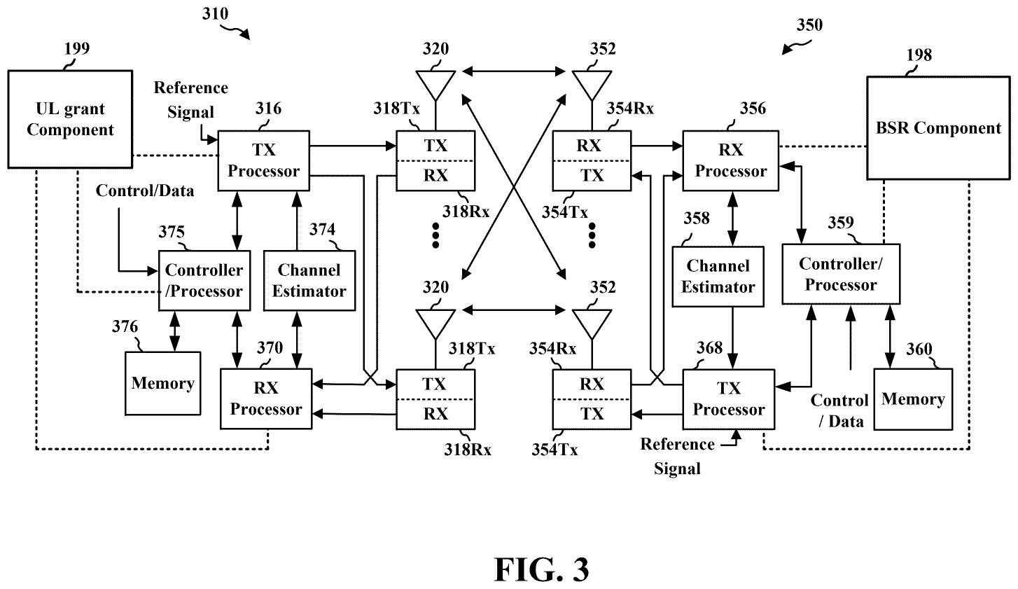

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the BSR component 198 of FIG. 1. At least one of the TX processor 316, the RX processor 370, and the controller/processor 375 may be configured to perform aspects in connection with the UL grant component 199 of FIG. 1.

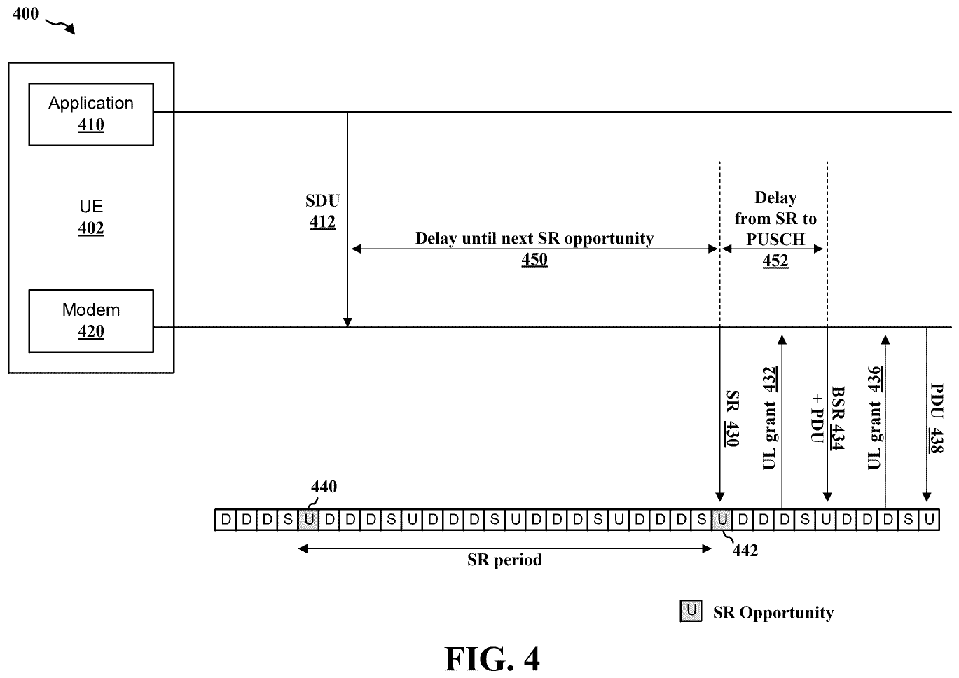

FIG. 4 is a diagram 400 of a method of wireless communication including a BSR. The diagram 400 may include a UE 402 including an application 410 and a modem 420. In one aspect, an arrival of a service data unit (SDU) 412 in an empty buffer of the modem 420 may trigger a transmission of a scheduling request (SR) 430 and the BSR 434. That is, the application 410 may transmit data to the modem via at least one SDU 412, the at least one SDU 412 carrying the data from the application 410 may arrive at the modem 420, more particularly, the buffer of the modem 420. Based on the arrival of the at least one SDU 412 in the buffer of the modem 420, which may be empty, the UE may transmit the SR 430 to the network node, and transmit the BSR based on the data saved in the buffer of the modem 420. Based on the SR 430 received from the UE 402, the network node may transmit an uplink (UL) grant 432 to the UE 402, and the UE 402 may transmit the BSR 434 to the network node in the slot indicated by the UL grant 432. Here, the UL channel indicated by the UL grant 432 may also be configured for transmitting the PDU based on the SDU 412, and the BSR 434 may be transmitted with the PDU. The network node may determine that, based on the BSR 434, that mode UL transmission may be configured to properly transmit the data associated with the SDU 412, the network node may transmit another UL grant 436 and the UE may transmit the PDU 438 based on the UL grant 436.

In one aspect, the SDU 412 of the UE may arrive in the buffer of the modem 420 of the UE 402 after an SR opportunity (e.g., UL slot 440) and end up waiting or holding the transmission of the SDU 412 until the next SR opportunity, and the maximum value of the delay may be equal to the SR period. Here, the SR period may be 20 slots, and because the SDU 412 from the application 410 may arrive at the modem 420 of the UE 402 after the UL slot 440, the UE may wait until the subsequent SR opportunity 442 to transmit the SR 430 to the network node. Accordingly, the delay until the next SR opportunity 450 may be added to the network latency.

Furthermore, the delay between the SR and the PUSCH 452 in response to the SR 430 may further be added to the network latency. The delay between the SR and the PUSCH 452 based on the SR 430 may depend on the network node's implementation, such as frame pattern (e.g., slot format). Here, the diagram 400 shows that the frame pattern has the slot format of DDDSU in TDD. These two delays may cause an issue for latency-sensitive applications.

In some aspects, a configured grant or a pre-scheduling of the UL transmission may allow the UE to transmit the BSR without the SR. That is, to allow the UE to transmit the BSR without the SR to reduce the network overhead, the network node may provide at least one of a configured grant of the UL transmission or a pre-scheduling of the UL transmission. In one aspect, in the case including the configured grant, the network node may need to know the period, offset, and size of the SDU to support the configured grant, which may not be available to the network node. In another aspect, in case of the pre-scheduling of the UL channels, the UE may not have data to transmit for some of the pre-scheduled PUSCH allocations may and not use the pre-scheduled PUSCH, which may cause a waste of radio resources.

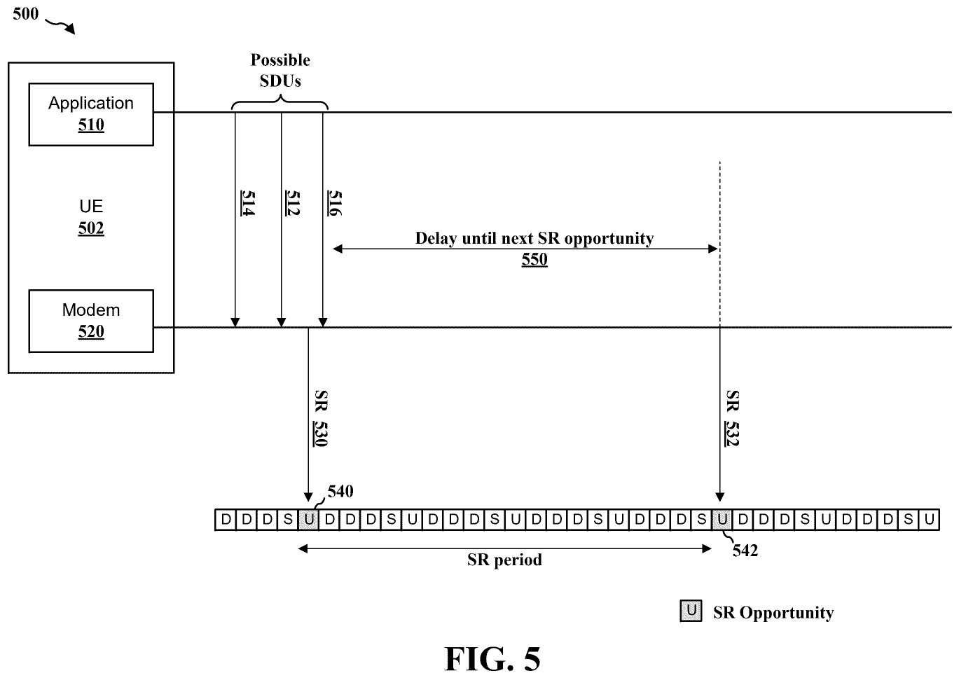

FIG. 5 is a diagram 500 of a method of wireless communication including the BSR. The diagram 500 may include a UE 502 including an application 510 and a modem 520. In some aspects, the SDU transmissions from the application 510 to the modem 520 may be quasi-periodic. That is, the application 510 may generate and send a flow of data transmission in a periodic SDU with some jitter. Here, the jitter may refer to a variation in the delay of packets received by the modem from the application. For example, the jitter may be caused by processing time for the amount of data at the application level.

In some aspects, the SR and the SDU traffic may be configured to have the same period to reduce the network latency or delay. In one example, the UE (or the modem 520 of the UE) may configure the periodicity of the SR based on the periodicity of the SDU traffic. In another example, the UE (or the modem 520 of the UE) may instruct the application 510 to configure the periodicity of the SDU traffic based on the periodicity of the SR. By configuring the SR close to the arrival time based on the periodicity of the SDU, the delay until the next SR opportunity 550 (e.g., the next UL slot 542) may be reduced.

In case the SR and the traffic are configured to have substantially the same period, an SR configured close to the arrival time of the SDUs based on the same periodicity may cause network delay due to the jitter. That is, each SDU may be delayed by the jitter, and the delayed SDU may not arrive at the modem of the UE in time for the SR configured for the corresponding arrival time of the SDU. Due to the jitter, the arrival time of the SDU received at the modem 520 may vary, and if the SR is configured close to the arrival time of the SDUs based on the periodicity of the SDU, an SDU received after the SR opportunity due to the jitter may suffer a long delay until the next SR opportunity. In one example, if the SR is delayed enough after the arrival time configured based on the SDU periodicity, then the delayed SDUs may be subject to useless delay, and hurt the mean network latency. In another example, if the SR is configured close to the arrival times, some of the SDUs with some delay due to the jitter may miss the SR, and they may have to wait for the subsequent SR opportunity, which may hurt the overall latency.

For example, the diagram 500 shows the SDU 512 may arrive early or late due to some jitter. That is, the modem 520 may instruct the application 510 to transmit the SDU 512 and configure the SR 530 in the SR opportunity 540 based on the arrival time of the SDU 512, and due to the jitter, the SDU 514 may be transmitted prior to the SDU 512 or the SDU 516 may be transmitted subsequent to the SDU 516. In one example, if the SDU 514 is received at the modem 520 prior to the arrival time of the SDU 512, the SDU 514 may have slightly increased delay until SR 530, but the data of the SDU may be transmitted to the network node based on the SR 530 in the SR opportunity 540. In another example, if the SDU 516 is received at the modem 520 after the arrival time of the SDU 512, the data of the SDU 516 may not be transmitted to the network node based on the SR 530 in the SR opportunity 540, and the delay until the next SR opportunity 550 (e.g., next UL slot 542) to send the SR, e.g., SR 532, may significantly increase, e.g., up to the SR period.

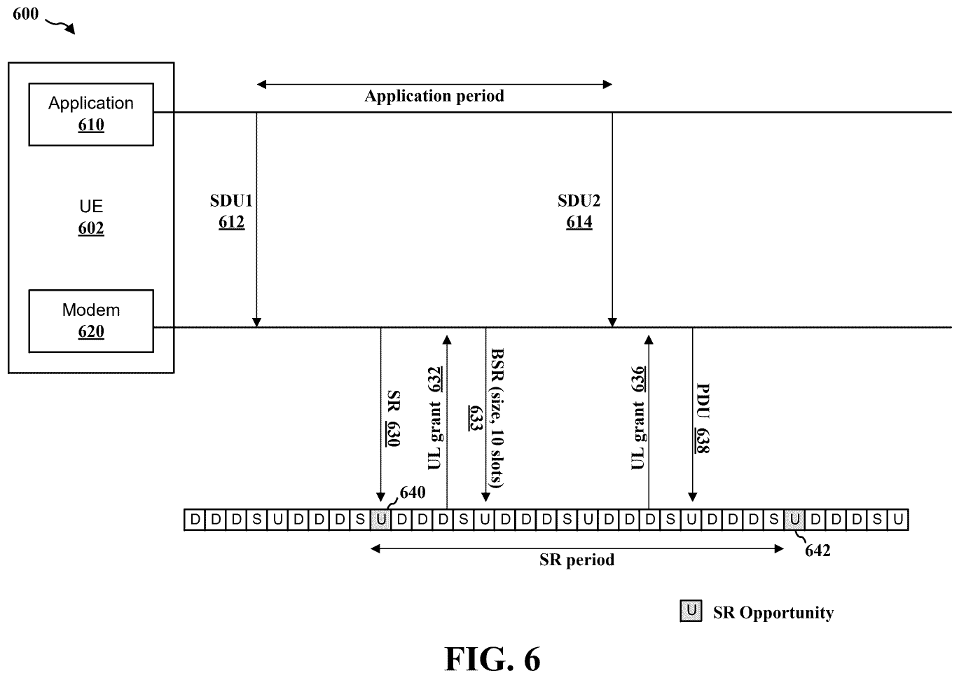

FIG. 6 is a diagram 600 of a method of wireless communication including the BSR. The diagram 600 may include a UE 602 including an application 610 and a modem 620. In one aspect, the application 610 and/or the modem 620 may take advantage of the quasi-periodic pattern of the SDU and estimate (or predict) the arrival of the next SDU, either through a configuration, or through the AI/ML. That is, because the SDU (e.g., SDU1 612 and SDU2 614) may be quasi-periodic (e.g., periodic configuration of application period with some jitter), the at least one of the application 710 and/or the modem 620 may estimate the arrival time of the subsequent SDU. Based on the arrival time of the SDU received in the buffer of the modem 620, the modem 620 may estimate the arrival time of the next SDU to be received from the application 610. Also, based on the arrival time of the SDU transmitted to the modem 620, the application 610 may estimate the arrival time of the next SDU to be transmitted to the modem 620.

Here, the estimation may be based on a configuration or a AI/ML model. In one aspect the estimation may be configured for the UE 602. In one example, based on a category or at least one property of the SDU1 612, the application 610 or the modem 620 of the UE 602 may be configured to estimate the arrival time and/or the size of the SDU2 614 based on the SDU1 612. In another example, the application 610 or the modem 620 of the UE 602 may include the AI/ML model for estimating the future SDU, and the application 610 or the modem 620 of the UE 602 may estimate the arrival time and/or the size of the SDU2 614 based on the SDU1 612 using the AI/ML model.

In one aspect, the estimation of the arrival time of the next SDU (or the future SDU) may include the estimation of the jitter associated with the next SDU. That is, the UE 602 may be configured to estimate the jitter associated with the next SDU and take the estimated jitter into account to determine the arrival time of the next SDU. Based on the estimated arrival time of the next SDU, the UE may schedule or configure the next PUSCH to transmit the data in the estimated SDU via a PDU.

In addition to the arrival time, the size of the next SDU may also be estimated. That is, based on the size of the SDU received in the buffer of the modem 620, the modem 620 may estimate the size of the next SDU to be received from the application 610. Also, based on the size of the SDU transmitted to the modem 620, the application 610 may estimate the size of the next SDU to be transmitted to the modem 620.

Here, the modem 620 may receive the SDU1 612 from the application 610. Based on the SDU1 612, the application 610 or the modem 620 may estimate the SDU2 614 to arrive in the buffer of the modem 620 in the future. The estimation of the SDU2 614 may include at least the arrival time of the SDU2 614 or the size of the SDU2 614.

The modem 620 may use the estimation of the SDU2 614 to transmit an SR and the BSR ahead of the actual arrival of a future SDU (e.g., the SDU2 614) in the buffer. That is, based on the estimation of the SDU2 614 based on the SDU1 612, the modem 620 of the UE 602 may signal to the network node of the estimation of the SDU2 614 to configure the next PUSCH for transmitting the data of the SDU2 614.

For example, based on the estimation of the SDU2 614, the UE 602 may first transmit the SR 630 to send the BSR 633 to the network node. The network node may transmit the UL grant 632, based on the SR 630 received at the SR opportunity 640, to the UE 602, the UL grant 632 indicating the UL resource for the UE 602 to transmit the BSR 633 indicating the estimation of the SDU2 614. Here, in the PUSCH transmitted based on the SR 630, the UE 602 may transmit the BSR to signal when the next PUSCH may be transmitted to match the arrival time of the estimated SDU (e.g., the SDU2 614), and optionally the estimated size of the estimated SDU (e.g., the SDU2 614). The BSR 633 may include or indicate at least one of the size (e.g., the estimated size) of the SDU2 614 or the slot for transmitting the PUSCH including the data of the SDU2 614 based on the estimated arrival time of the SDU2 614. In one example, the BSR may include 10 slots, indicating the network node that the PDU 638 including the data of the SDU2 614 may be transmitted after 10 slots from the transmission of the BSR before the next SR opportunity 642. Based on the BSR 633 including or indicating the at least one of the size (e.g., the estimated size) of the SDU2 614 or the time slot for transmitting the PUSCH including the data of the SDU2 614, the network node may transmit the UL grant 636 configuring the PUSCH for the UE 602 to transmit the PDU 638. Here, the PUSCH may have the time-frequency resource allocation corresponding with the at least one of the size (e.g., the estimated size) of the SDU2 614 or the time slot for transmitting the PUSCH including the data of the SDU2 614 based on the estimation of SDU2 614. Here, the UL grant 636 may be received at the modem 620 before or after the arrival of the SDU2 614 at the modem 620 from the application 610. The UE 602 may transmit the PDU 638 based on the UL grant 636 received from the network node to transmit the data in the SDU2 614 based on the estimation of the SDU2 614.

The diagram 600 indicates that the estimation of the SDU2 614 may be generated based on one past SDU (e.g., the SDU1 612), but the aspects of the current disclosure are not limited there to, and multiple past SDUs including the SDU1 612 may be configured to estimate the arrival time and/or the size of the SDU2 614. Furthermore, multiple future SDUs may be estimated base on one or more past SDUs received at the modem 620 of the UE 602.

Here, the estimation of the arrival time (and/or the size) of the future SDUs may be done either by the application 610 or by the modem 620. When the estimation is available to the modem 620, the modem may trigger the BSR 633, compared to a case where an arrival of the SDU at the empty buffer may trigger the BSR.

In one aspect, the modem 620 may be configured to trigger the BSR 633 based on the estimation of a future SDU (e.g., the SDU2 614) is known. Furthermore, the BSR may trigger the transmission of the SR 630 if no UL grant is received before the next estimated SDU2 614.

In another aspect, the network node may configure the UL configured grants that may be dedicated to transmitting the BSR 633. That is, the UL may configure a configured grant for the UE, and the configured grant may schedule the UL slots for the UE to transmit the BSR 633 based on the estimation of the SDU2. If the UE has no estimation and therefore, no BSR to send, the UE may be configured to skip the transmission of the configured grant.

In some aspects, based on the estimation of the future SDU (e.g., the SDU2 614), the BSR of the future SDU may be triggered based on the estimation of the future SDU, and the UE may transmit the SR (e.g., the SR 630) before the arrival of the future SDU (e.g., the SDU2 614) to transmit the BSR (e.g., BSR 633). Based on the triggering of the BSR associated with the future SDUs, the future SDU may or may not have arrived in the buffer before the BSR is transmitted to the network node.

In one example, the SDU associated with the estimation that triggered the BSR may have arrived in the buffer of the modem of the UE before the transmission of the BSR, and the UE may transmit the BSR including the actual size of the SDU without any further timing information. Based on the BSR, the network node may transmit subsequent UL grants to configure the UE with the network resources for transmitting the PUSCH carrying the data of the SDU. Here, the UL grant may be configured based on the actual size of the SDU that already arrived in the buffer of the modem.

In another example, the SDU associated with the estimation that triggered the BSR may not have arrived in the buffer of the modem of the UE before the transmission of the BSR, and the UE may transmit the BSR with a dedicated format including the estimated size of the SDU and/or a timing information. Here, a dedicated format of the BSR may be provided to include the time when the next PUSCH may be transmitted (e.g., the target PUSCH). That is, if the SDU has not arrived yet in the buffer, the UE may transmit a new BSR with a dedicated format to report the expected size (if available) of the BSR and the time when the target PUSCH may be transmitted to deliver the BSR and/or the PDU of the SDU. Accordingly, the UE and the network node may be configured with the dedicated format of the BSR which may include the estimated size of the future SDU and/or the estimated time that the target PUSCH may be configured by the network node to transmit the PDU carrying the data of the future SDU. For example, the timing of the target PUSCH may be signaled as the number of slots, starting from the PUSCH that contains the BSR. Also, the estimated size may be reported (e.g., a BSR table), in the BSR if available.

For example, the SDU2 614 did not arrive in the modem 620 before the transmission of the BSR 633, and the UE 602 may send the BSR including the estimated size of the SDU2 614 and the target PUSCH to transmit the PDU 638. Here, the BSR 633 may indicate 10 slots, and the network node may transmit the UL grant 636 to allocate the network resources 10 slots from the transmission of the BSR for the target PUSCH to transmit the PDU 638.

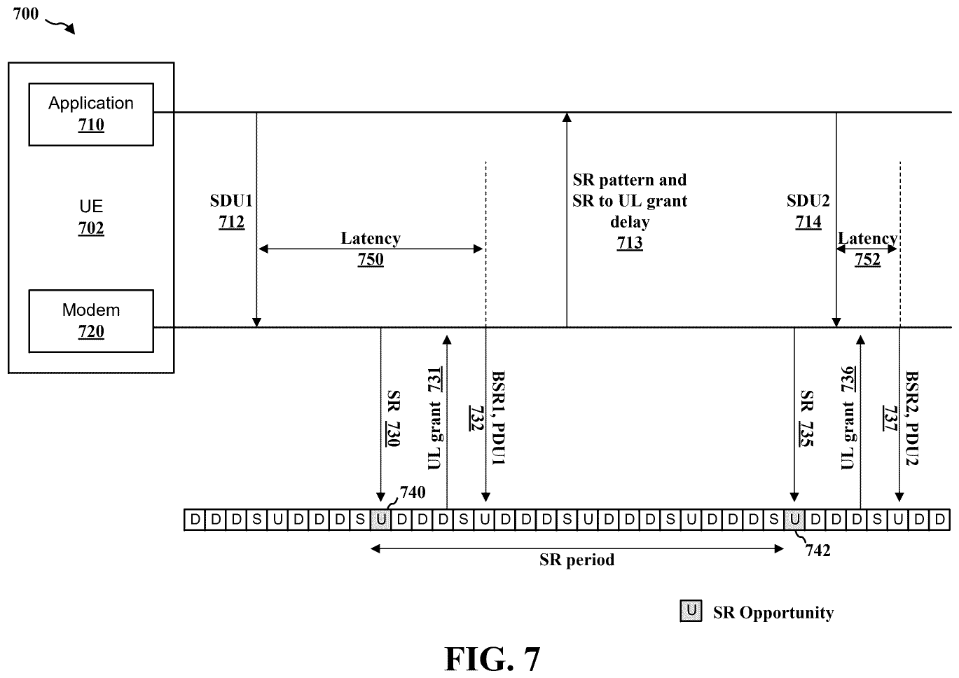

FIG. 7 is a diagram 700 of a method of wireless communication including the BSR. The diagram 700 may include a UE 702 including an application 710 and a modem 720. In some aspects, the modem 720 of the UE 702 may instruct (or configure) the application 710 to align the SDU traffic based on the estimation of the next SDU2.

First, the arrival of SDUs in an empty buffer may trigger the BSR, which may trigger the transmission of the SR. Here, based on the arrival of the SDU1 712 in the buffer of the modem 720 of the UE 702, the modem 720 may be configured to transmit the SR 730 requesting the network node to configure network resources for transmitting the BSR and/or the PDU1 carrying the data of the SDU1. Based on the SR 730, the UE 702 may receive the UL grant 731 and transmit the BSR1 and/or the PDU1 732 to the network node based on the UL grant 731.

Here, a latency 750 may occur between the arrival of the SDU1 712 at the modem 720 of the UE and the transmission of the BSR1 and/or the PDU1 732. That is, the BSR1 and/or the PDU1 732 may be transmitted to the network node after the latency 750 from the arrival of the SDU1 712. The latency 750 may include a first latency component between the arrival time of the SDU1 712 and the first available SR opportunity 740, and a second latency component between the first available SR opportunity 740 and the transmission of the BSR and/or the PDU1 732. In one aspect, the first latency component of the latency 750 may be reduced by aligning the arrival time SDU1 712 so that the SDU1 712 may be delivered before, but as close as possible to, the first available SR opportunity 740.

In another aspect, the second latency component of the latency 750 may follow a predictable pattern. For example, in case of the TDD−SCS=30 kHz configuration with the slot format of DDDSU, the second latency component of the latency 750 may be estimated as 1.5 ms. In one example, the modem 720 and the UE 702 may be estimate the second latency component of the latency 750 based on a configuration, or the AI/ML model. The modem 720 may report the estimated information to the application 710 so that the application 710 may align the delivery of the future UL SDUs (e.g., the SDU2) based on the UL grant.

For example, the modem 720 may report the information associated with the second latency component of the latency 750 or 752 to the application 710, and instruct the application 710 to align the SDU2 to reduce the latency 752. Here, the information associated with the second latency component of the latency 750 or 752 may include the SR pattern and/or the SR to UL grant delay 713. Based on the SR pattern and/or the SR to UL grant delay 713, the application 710 may align the SDU2 to be as close as the PUSCH to reduce the latency 752. From the estimation of the arrival time of the next SDU (e.g., the SDU2 714), the BSR may be triggered so that the modem 720 may transmit the SR 735 in the closest opportunity (e.g., the closest SR opportunity 742) that is ahead of the arrival time of the SDU2 714 in the buffer.

In one aspect, the modem 720 may report the timing information including the SR pattern and/or the delay between the SR and the UL grant 731 to the application 710 through a cross-layer API. In another aspect, the application 710 may align the delivery of the future SDUs (e.g., SDU2 714) based on the timing information (e.g., the SR pattern and/or the SR to UL grant delay 713) received from the modem 720, to reduce the latency 752. For example, the delivery of the future SDUs (e.g., SDU2 714) may be aligned considering the time for the modem to build the MAC PDU of the PDU2 based on the SDU2.

In another aspect, based on the estimation of the arrival time of the SDU2 714, the modem 720 may trigger the BSR2 so that the modem transmits the SR 735 in the closest SR opportunity 742 that is ahead of the arrival of the SDU2 714 in the buffer. The network node may transmit UL grant 736 based on the SR 735, and the UE 702 may transmit the BSR2 and the PDU2 737 of the SDU2 714 based on the UL grant 736 received from the network node. By sending the SR 735 in the closest SR opportunity 742 that is ahead of the arrival of the SDU2 714 in the buffer, the UE 702 may eliminate the first latency component of the latency 752 and reduce the second latency component of the latency 752, reducing the latency 752 associated with transmitting the data of the SDU2 in the PDU2 737.

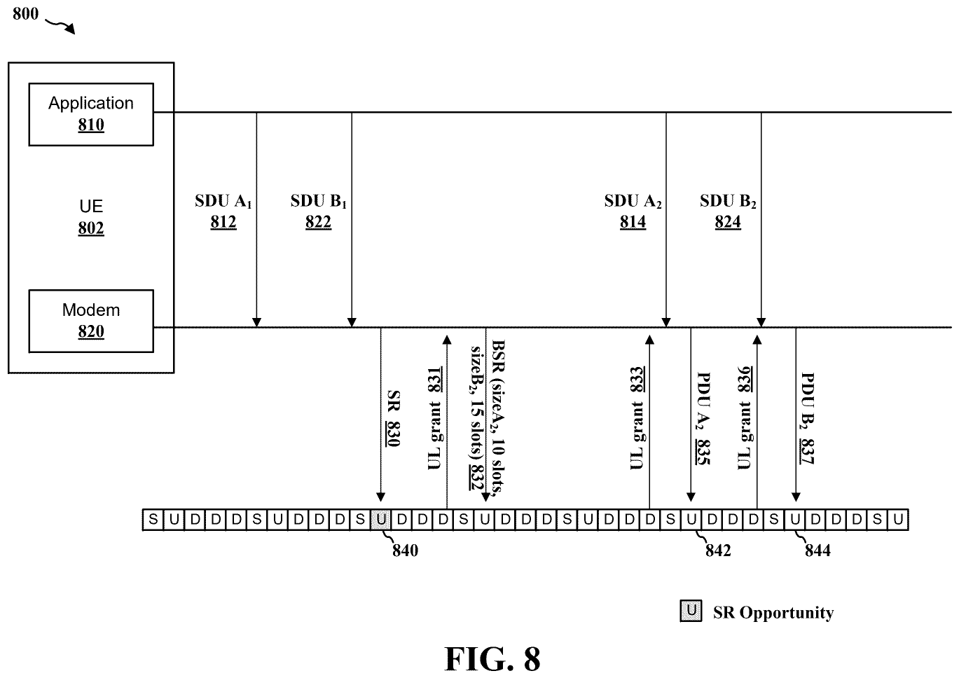

FIG. 8 is a diagram 800 of a method of wireless communication including the BSR. The diagram 800 may include a UE 802 including an application 810 and a modem 820. The diagram 800 illustrates that more than one SDUs (e.g., multiple SDUs) may be scheduled or communicated between the application 810 and the UE 802. The multiple SDUs may be delivered by the application 810 in between two consecutive SR opportunities. The multiple SDUs may be from the same or from different flows. Here, the SDU A₁ 812 and SDU B₁ 822 may be from different data flows and may be received at the buffer of the modem 820 between two consecutive SR opportunities.

Here, the BSR may support signaling the estimated information about the multiple SDUs or the BSR may include the estimated information about the earliest future SDU. The UE and the network node may be configured to select or switch to include the estimated information about the multiple SDUs or the earliest future SDU. In one example, the network node may instruct the UE to include the estimated information about the multiple SDUs in the BSR or include the estimated information about the earliest future SDU in the BSR. In another example, the UE may indicate the network node that the UE may include the estimated information about the multiple SDUs in the BSR or include the estimated information about the earliest future SDU in the BSR.

In some aspects, the BSR may support signaling the estimated size and/or the timing of the target PUSCH for the multiple SDUs. For each SDU of the multiple SDUs may be estimated to be received from the application until the next SR opportunity, and the UE may signal the network node, via the BSR with the dedicated format, the estimated size and target PUSCH associated with each SDU of the multiple SDUs. That is, the BSR may carry information of at least one estimation of the multiple SDUs arrived in the buffer of the modem.

For example, the modem 820 of the UE 802 may receive the SDU A₁ 812 and SDU B₁ 822 from the application 810 and initiate the transmission of the BSR 832. Based on the SDU A₁ 812 and SDU B₁ 822, at least one of the application 810 or the modem 820 may estimate multiple future SDUs, e.g., the SDU A₂ 814 and the SDU B₂ 824. The estimation may include the respective sizes the SDU A₂ 814 and the SDU B₂ 824 and the timing of the PUSCHs for transmitting the SDU A₂ 814 and the SDU B₂ 824.

The UE 802 may transmit an SR 830 in the SR opportunity 840 to and receive the UL grant 831 for transmitting the BSR 832. Here, the BSR 832 may include the estimation of the SDU A₂ 814 and the SDU B₂ 824. The BSR 832 may indicate the size of the SDU A₂ 814 and the SDU B₂ 824, and that the first target PUSCH for transmitting the SDU A₂ 814 may be scheduled after 10 slots from the BSR 832 and that the second target PUSCH for transmitting the SDU B₂ 824 may be scheduled after 15 slots from the BSR 832.

Based on the BSR 832, the network node may send the UL grant 833 scheduling the first target PUSCH in the first target slot 842 for the SDU A₂ 814, and the UE 802 may receive the SDU A₂ 814 and transmit the PDU A₂ 835 in the first target PUSCH based on the UL grant 833. The network node may also send the UL grant 836 scheduling the second target PUSCH in the second target slot 844 for the SDU B₂ 824, and the UE 802 may receive the SDU B₂ 824 and transmit the PDU B₂ 837 in the second target PUSCH based on the UL grant 836.

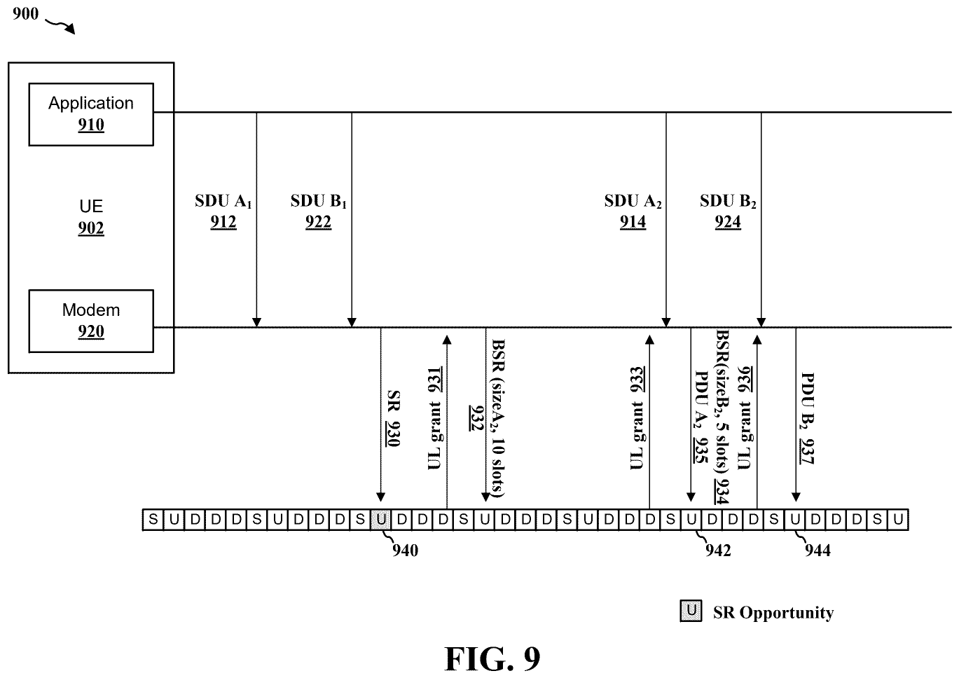

FIG. 9 is a diagram 900 of a method of wireless communication including the BSR. The diagram 900 may include a UE 902 including an application 910 and a modem 920. In some aspects, the BSR may include the information of estimation about the earliest future SDU. That is, BSR may support signaling the estimated size and/or the timing of the target PUSCH for the SDU estimated to subsequently arrive in the buffer of the modem 920 of the UE 902. Here, the modem 920 may send the BSR with the estimation information of the earliest future SDU, the overhead from the BSR with new format may be reduced.

For example, the modem 920 of the UE 902 may receive the SDU A₁ 912 and SDU B₁ 922 from the application 910 and initiate the transmission of the BSR 932. Based on the SDU A₁ 912 and SDU B₁ 922, at least one of the application 910 or the modem 920 may estimate multiple future SDUs, e.g., the SDU A₂ 914 and the SDU B₂ 924. The estimation may include the respective sizes the SDU A₂ 914 and the SDU B₂ 924 and the timing of the PUSCHs for transmitting the SDU A₂ 914 and the SDU B₂ 924.

The UE 902 may transmit an SR 930 in the SR opportunity 940 to and receive the UL grant 931 for transmitting the BSR 932. In the PUSCH scheduled by the SR 930, the modem 920 of the UE 902 may send the BSR 932 with the information about the SDU A₂ 914. The BSR 932 may indicate the size of the SDU A₂ 914 and that the first target PUSCH for transmitting the SDU A₂ 914 may be scheduled after 10 slots from the BSR 932. Based on the BSR 932, the network node may send the UL grant 933 scheduling the first target PUSCH in the first target slot 942 for the SDU A₂ 914, and the UE 902 may receive the SDU A₂ 914 and transmit the PDU A₂ 935 in the first target PUSCH based on the UL grant 933.

The UE 902 may also transmit the BSR 934 associated with the SDU B₂ 924 in the first target PUSCH with the PDU A₂ 935. Based on the BSR 934, the network node may send the UL grant 936 scheduling the second target PUSCH in the second target slot 944 for the SDU B₂ 924, and the UE 902 may receive the SDU B₂ 924 and transmit the PDU B₂ 937 in the second target PUSCH based on the UL grant 936. The BSR 934 may indicate the size of the SDU B₂ 924, and that the second target PUSCH for transmitting the SDU B₂ 924 may be scheduled after 5 slots from the BSR 934.

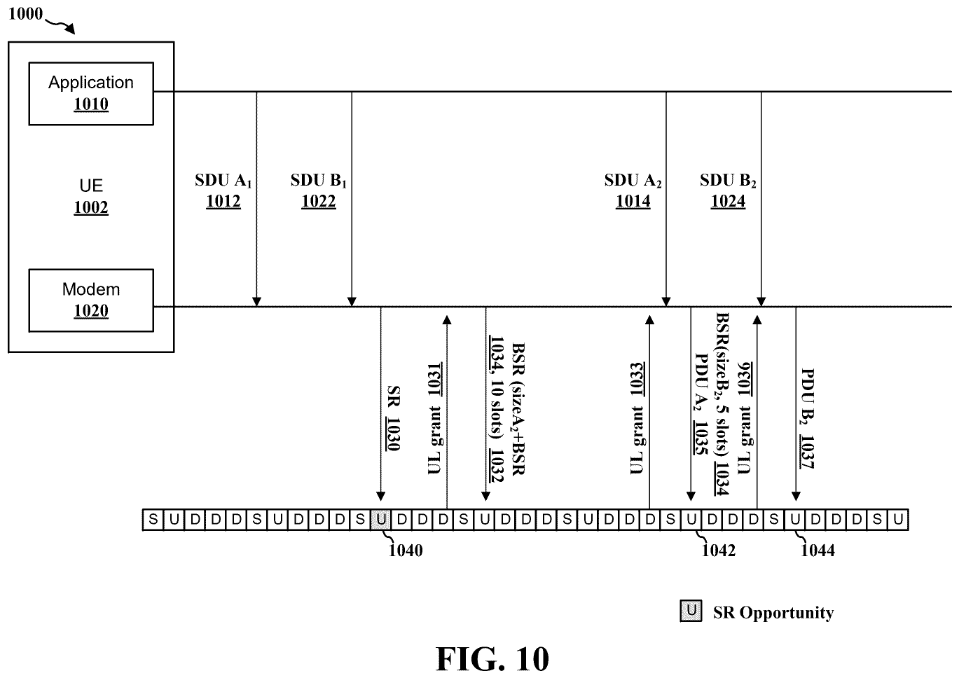

FIG. 10 is a diagram 1000 of a method of wireless communication including the BSR. The diagram 1000 may include a UE 1002 including an application 1010 and a modem 1020. In another aspect, the BSR may include the information of estimation about the earliest future SDU, and in case the BSR indicates that in the target PUSCH includes the PDU as well as the subsequent BSR associated with the future SDU, the BSR may indicate the network that the target PUSCH may have the size to support the PDU and the subsequent BSR.

For example, the modem 1020 of the UE 1002 may receive the SDU A₁ 1012 and SDU B₁ 1022 from the application 1010 and initiate the transmission of the BSR 1032. Based on the SDU A₁ 1012 and SDU B₁ 1022, at least one of the application 1010 or the modem 1020 may estimate multiple future SDUs, e.g., the SDU A₂ 1014 and the SDU B₂ 1024. The estimation may include the respective sizes of the SDU A₂ 1014 and the SDU B₂ 1024 and the timing of the PUSCHs for transmitting the SDU A₂ 1014 and the SDU B₂ 1024.

The UE 1002 may transmit an SR 1030 in the SR opportunity 1040 to and receive the UL grant 1031 for transmitting the BSR 1032. In the PUSCH scheduled by the SR 1030, the modem 1020 of the UE 1002 may send the BSR 1032 with the information about the SDU A₂ 1014. The BSR 1032 may indicate the size of the SDU A₂ 1014 and that the first target PUSCH for transmitting the SDU A₂ 1014 may be scheduled after 10 slots from the BSR 1032.

Here, the size of this target PUSCH for SDU A₂ 1014 may take the size of the new the BSR into account. That is, when transmitting the BSR 1032 for SDU A₂ 1014, the UE 1002 may include the size of the BSR 1034 for the SDU B₂ 1024 in the amount of data waiting for transmission. Based on the BSR 1032, the network node may send the UL grant 1033 scheduling the first target PUSCH in the first target slot 1042 for the SDU A₂ 1014 and the BSR 1034 associated with the SDU B₂ 1024, and the UE 1002 may receive the SDU A₂ 1014 and transmit the PDU A₂ 1035 with the BSR 1034 associated with the SDU B₂ 1024 in the first target PUSCH based on the UL grant 1033.

The BSR 1034 associated with the SDU B₂ 1024 is transmitted in the first target PUSCH with the PDU A₂ 1035. Based on the BSR 1034, the network node may send the UL grant 1036 scheduling the second target PUSCH in the second target slot 1044 for the SDU B₂ 1024, and the UE 1002 may receive the SDU B₂ 1024 and transmit the PDU B₂ 1037 in the second target PUSCH based on the UL grant 1036. The BSR 1034 may indicate the size of the SDU B₂ 1024, and that the second target PUSCH for transmitting the SDU B₂ 1024 may be scheduled after 5 slots from the BSR 1034.

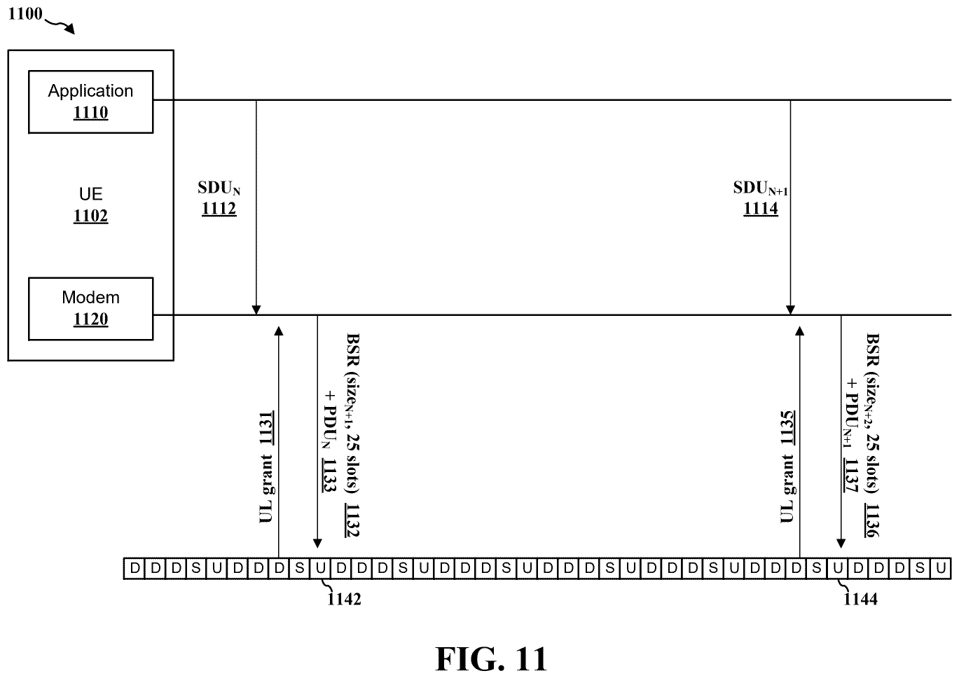

FIG. 11 is a diagram 1100 of a method of wireless communication including the BSR. The diagram 1100 may include a UE 1102 including an application 1110 and a modem 1120. In some aspects, the UE 1102 may include the BSR including the estimation of the future SDU with the transmission of the SDU arrived at the buffer of the modem 1120. Here, the estimation of one or more subsequent SDUs may be generated or obtained based on one or more SDUs previously arrived in the buffer of the modem 1120, and in case a series of multiple SDUs is communicated between the application 1110 and the modem 1120 of the UE 1102, the UE 1102 may obtain the estimation of the arrival time and/or the size of the SDU_{N+1} upon delivery of the SDU_{N} from the application 1110 to the modem 1120. In case the modem 1120 may obtain the estimation of the SDU_{N+1} based on the SDU_{N}, the modem 1120 may indicate in the BSR the estimated information about the next SDU_{N+1} while transmitting the PDU_{N} of the SDU_{N}. Accordingly, the UE and the network node may reduce the number of SR transmissions.

For example, the modem 1120 may receive the SDU_{N} 1112 from the application 1110. Based on the SDU_{N} 1112, the application 1110 or the modem 1120 may estimate the SDU_{N+1} 1114 to arrive in the buffer of the modem 1120 in the future. The estimation of the SDU_{N+1} 1114 may include at least the arrival time of the SDU_{N+1} 1114 or the size of the SDU_{N+1} 1114.

The UE 1102 may receive the UL grant 1131 indicating the first target slot 1142 for the UE 1102 to transmit the BSR 1132 indicating the estimation of the SDU_{N+1} 1114 and the PDU_{N} 1133 carrying the data of the SDU_{N} 1112. The BSR 1132 may include the estimated size of the SDU_{N+1} 1114 and the time when a second target PUSCH may be transmitted to deliver the BSR 1136 and the PDU_{N+1} 1137. For example, the BSR 1132 may indicate that the second target slot 1144 when the second target PUSCH may be transmitted to deliver the BSR 1136 and the PDU_{N+1} 1137 may be scheduled after 25 slots from the transmission of the BSR 1132.

Based on the BSR 1132, the network node may transmit the UL grant 1135 to schedule the second target PUSCH for the UE 1102 to transmit the BSR 1136 indicating the estimation of the SDU_{N}+2 and the PDU_{N+1} 1137 carrying the data of the SDU_{N+1} 1114. The UE 1102 may receive the UL grant 1135 indicating the second target slot 1144 for the UE 1102 to transmit the BSR 1136 indicating the estimation of the SDU_{N}+2 and the PDU_{N+1} 1137 carrying the data of the SDU_{N+1} 1114. The BSR 1136 may include the estimated size of the SDU_{N}+2 and the time when a third target PUSCH may be transmitted to deliver the BSR 1136 and the PDU_{N+1} 1137. For example, the BSR 1136 may indicate the third target slot when the third target PUSCH may be transmitted to deliver the subsequent BSR and the PDU may be scheduled after 25 slots from the transmission of the BSR 1136.

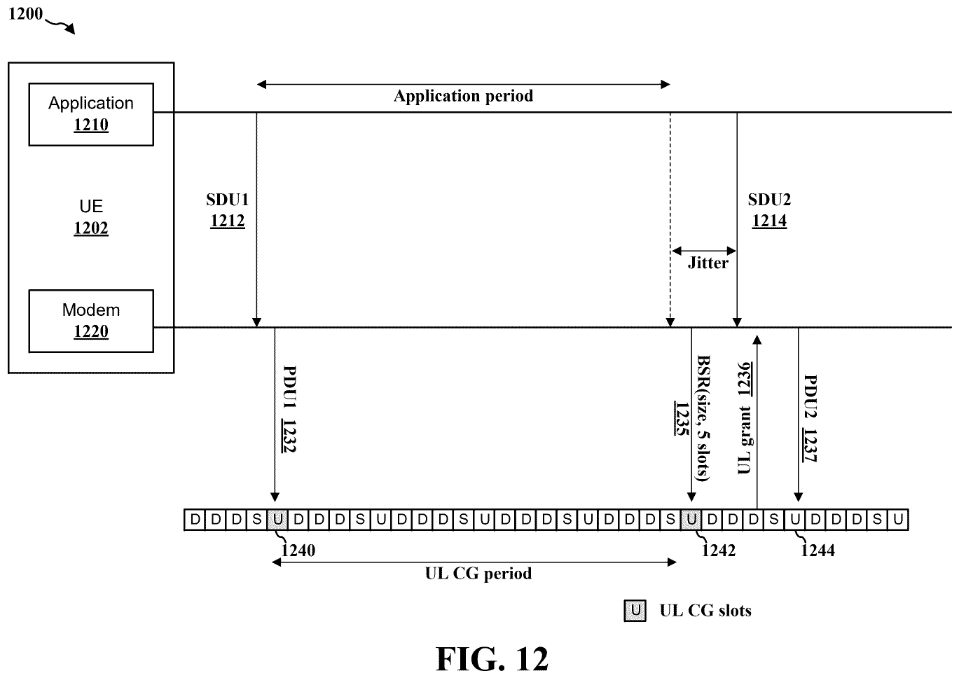

FIG. 12 is a diagram 1200 of a method of wireless communication including the BSR. The diagram 1200 may include a UE 1202 including an application 1210 and a modem 1220. In some aspects, the UEs with a quasi-periodic traffic may be configured with UL configured grant (CG). That is, the network node may configure the UL CG for the UEs with a quasi-periodic traffic, and the UE may transmit the UL data based on the UL CG with a UL CG period.

For example, the UE 1202 may estimate that the SDU1 1212 and the SDU2 1214 may be quasi-periodic traffic with an application period and some jitter. Based on the estimation, the network node may configure a UL CG at every 20 slots (UL CG period) for the UE to transmit the SDU1 1212 and SDU2 1214. The modem 1220 of the UE 1202 may receive the SDU1 1212 and transmit the PDU1 1232 of the SDU1 1212 in the first UL CG slot 1240 based on the UL CG configuration. If the SDU2 1214 is received at the application period, the UE 1202 may transmit a PDU2 of the SDU2 1214 at the second UL CG slot 1242 based on the UL CG configuration.

In one aspect, because of the jitter, some SDUs may arrive in the buffer after the UL CG opportunity, and some SDUs of the UE 1202 may miss a configured transmission opportunity (e.g., the second UL CG slot 1242) of the UL CG. When a delayed SDU misses a configured opportunity to transmit the UL CG, the UE 1202 may transmit a BSR including the information about the delayed SDU that missed the configured UL CG and the target PUSCH for transmitting the PDU associated with the delayed SDU. That is, if a delayed SDU misses the UL CG transmission opportunity, the UE 1202 may transmit the BSR with the information (or estimation) about the delayed SDU. That is, on the UL CG missed by the delayed SDU, the UE 1202 may transmit the BSR with the information on the target PUSCH of the late SDU that missed the UL CG. On reception of the new the BSR in the UL CG, the network node may send a dynamic grant (e.g., the UL grant) in an appropriate slot to schedule the target PUSCH as indicated by the BSR.

For example, the SDU2 1214 may be received at the modem 1220 of the UE 1202 with a delay (e.g., a jitter), past the second UL CG slot 1242. Accordingly, the UE 1202 may be configured to transmit the BSR 1235 including the size of the PDU2 1237 based on the SDU2 1214 and the target PUSCH in the target slot 1244 to transmit the PDU2 1237. Here, the BSR 1235 may indicate the size of the SDU2 1214, and that the target PUSCH for transmitting the SDU2 1214 may be scheduled after 5 slots from the BSR 1235. The network node may transmit a UL grant 1236 based on the BSR 1235 and schedule the target PUSCH in the target slot 1244. After the arrival of the SDU2 1214 at the buffer of the modem 1220 of the UE 1202, the UE 1202 may transmit the PDU2 1237 via the target PUSCH scheduled in the target slot 1244.

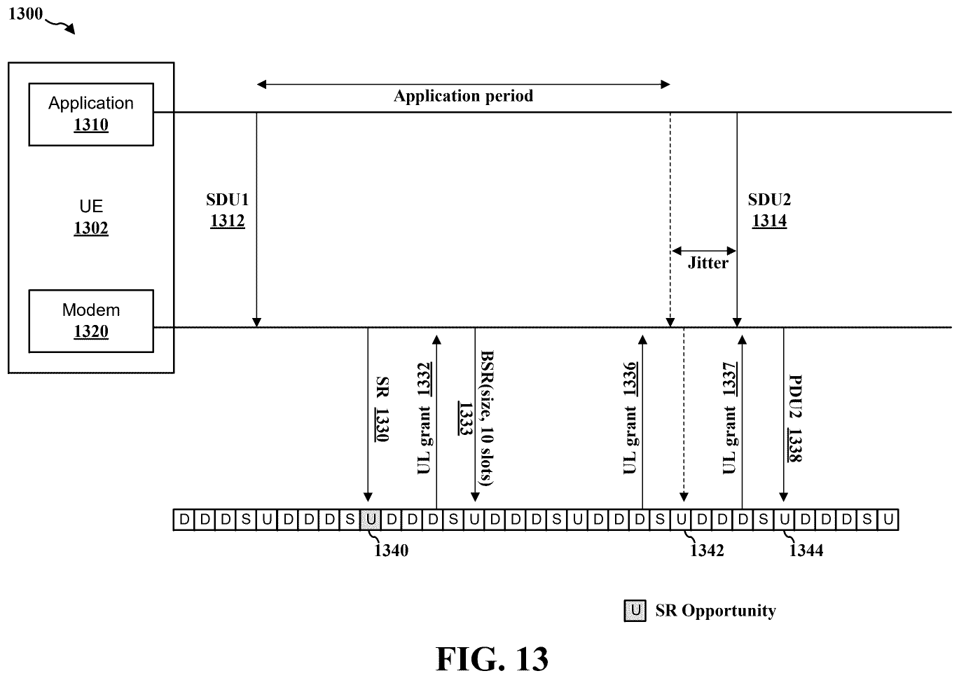

FIG. 13 is a diagram 1300 of a method of wireless communication including the BSR. The diagram 1300 may include a UE 1302 including an application 1310 and a modem 1320. In some aspects, the BSR may further include a request for multiple PUSCH scheduling. The estimation of the arrival time of the future SDU may be affected by the jitters and not be accurate. That is, some future SDUs may be delayed to arrive in the buffer after the estimated arrival time, and the delayed SDUs may not be transmitted to the network node in the target PUSCH scheduled based on the BSR. The BSR may include an indication of a plurality of target PUSCHs, and the network node may determine whether to schedule the plurality of target PUSCHs for the UE 1302 to transmit the SDU. In one aspect, the scheduling of the plurality of target PUSCHs may be based on the cell being not heavily loaded. In another aspect, the indication of the plurality of target PUSCHs may be a simple flag or an estimation of the number of additional PUSCHs for the network node to schedule. Based on the BSR, the network node may allocate additional PUSCH, either through multiple UL grants (e.g., multiple dynamic UL grants) or through one UL grant that allocates multiple consecutive PUSCH (e.g., semi-persistent scheduling).

In some aspects, the network may receive the BSR including the indication of the plurality of target PUSCHs, and schedule the plurality of target PUSCHs. Based on the BSR including the indication of the plurality of target PUSCHS, the network node may allocate several PUSCH, starting from the target one (e.g., if the cell is not heavily loaded). In one aspect, the network node may semi-persistently schedule the plurality of PUSCHs for the UE to transmit the SDU via the first available PUSCH among the plurality of PUSCHs upon arriving at the buffer of the modem 1320 of the UE 1302. In another aspect, the network node may send multiple dynamic grants (multiple UL grants) until receiving the PDU of the SDU from the UE 1302.

For example, the UE 1302 may estimate that the SDU1 1312 and the SDU2 1314 may be quasi-periodic traffic with an application period and some jitter. Based on the estimation of the SDU2 1314, the UE 1302 may first transmit the SR 1330 to send the BSR 1333 to the network node. The network node may transmit the UL grant 1332, based on the SR 1330 received at the SR opportunity 1340, to the UE 1302, the UL grant 1332 indicating the UL resource for the UE 1302 to transmit the BSR 1333 indicating the estimation of the SDU2 1314. Here, in the PUSCH transmitted based on the SR 1330, the UE 1302 may transmit the BSR 1333 to signal when the next PUSCH may be transmitted to match the arrival time of the estimated SDU (e.g., the SDU2 1314), and optionally the estimated size of the estimated SDU (e.g., the SDU2 1314). The BSR 1333 may include or indicate at least one of the size (e.g., the estimated size) of the SDU2 1314 or the slot for transmitting the PUSCH including the data of the SDU2 1314 based on the estimated arrival time of the SDU2 1314. In one example, the BSR may include 10 slots, indicating the network node that the PDU2 1338 including the data of the SDU2 1314 may be transmitted after 10 slots from the transmission of the BSR before the next SR opportunity.

In one aspect, because of the jitter, some SDUs may arrive in the buffer after the UL CG opportunity, and some SDUs of the UE 1302 may miss a configured transmission opportunity (e.g., the second UL CG slot) of the UL CG. To support the delayed SDU that may miss the first SR opportunity to transmit the UL CG, the UE 1302 may include the indication of the plurality of target PUSCHs in the BSR and the network node may configure the plurality of target PUSCHs based on the BSR.

For example, the SDU2 1314 may be received at the modem 1320 of the UE 1302 with a delay (e.g., a jitter), past the second UL CG slot. The BSR 1333 may include the indication of the plurality of target PUSCHs, and the network node may configure the plurality of target PUSCHs. The network node may transmit the UL grant 1336 to the UE to schedule the target PUSCH in the first target slot 1342. Because the SDU2 1314 was delayed and did not arrive before the first target slot 1342, the UE 1302 may not transmit the PDU2 of the SDU2 1314 in the first target slot 1342. The network node may transmit the UL grant 1337 to schedule the second target PUSCH in the second target slot 1344. The SDU2 1314 may arrive in the buffer of the modem 1320 of the UE 1302, and based on the UL grant 1337, the UE 1302 may transmit the PDU2 1338 of the SDU2 1314 to the network node. Here, the PUSCH may have the time-frequency resource allocation corresponding with the at least one of the size (e.g., the estimated size) of the SDU2 1314 or the time slot for transmitting the PUSCH including the data of the SDU2 1314 based on the estimation of SDU2 1314.

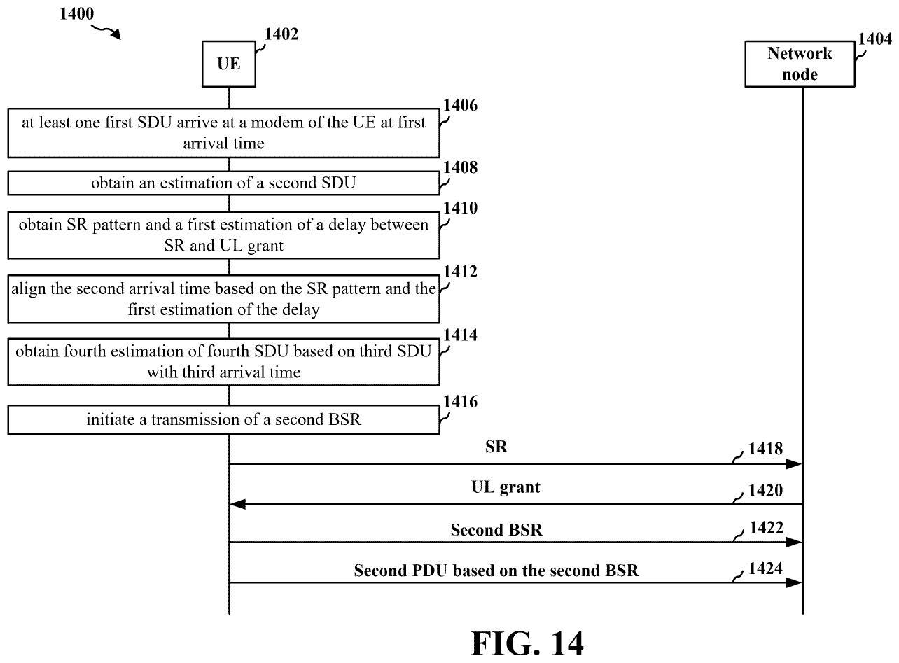

FIG. 14 is a call-flow diagram 1400 of a method of wireless communication. The call-flow diagram 1400 may include a UE 1402 and a network node 1404. The UE 1402 may be configured to obtain one or more estimations of one or more future SDUs based on one or more past SDUs and initiate a transmission of one or more BSR of the one or more future SDUs based on the one or more estimations of one or more future SDUs. The one or more estimations may include estimated arrival times of the one or more future SDUs and estimated size of the one or more future SDUs. Based on the BSR, the network node 1404 may configure UL grant for the UE 1402 to transmit the one or more BSR and one or more PDUs carrying the data of the one or more SDUs.

At 1406, at least one first SDU may arrive at a modem of the UE 1402 at a first arrival time. In one aspect, an arrival of a SDU in an empty buffer of the modem may trigger a transmission of an SR and the BSR.

At 1408, the UE 1402 may obtain an estimation of a second SDU based on at least one first SDU with a first arrival time at a modem of the UE 1402, the estimation of the second SDU including a second arrival time at the modem of the UE 1402, the second arrival time being after the first arrival time. The estimation of the second SDU may be done by the application or the modem of the UE 1402.

In one aspect, the estimation may be based on a configuration or a AI/ML model. In one aspect the estimation may be configured for the UE 1402. In one example, based on a category or at least one property of the first SDU, the application or the modem of the UE 1402 may be configured to estimate the arrival time and/or the size of the second SDU based on the first SDU. In another example, the application or the modem of the UE 1402 may include the AI/ML model for estimating the future SDU, and the application or the modem of the UE 1402 may estimate the arrival time and/or the size of the second SDU based on the first SDU using the AI/ML model.

In another aspect, the estimation of the arrival time of the second SDU may include the estimation of the jitter associated with the second SDU. That is, the UE 1402 may be configured to estimate the jitter associated with the second SDU and take the estimated jitter into account to determine the arrival time of the second SDU. Based on the estimated arrival time of the second SDU, the UE 1402 may schedule or configure the target PUSCH to transmit the PDU including the data in the second SDU via the target PUSCH.

The estimation of the second SDU may further include an estimated size of the second SDU based on a size of the at least one first SDU. That is, in addition to the arrival time, the size of the second SDU may also be estimated. That is, based on the size of the first SDU received in the buffer of the modem, the modem may estimate the size of the second SDU to be received from the application. Also, based on the size of the SDU transmitted to the modem, the application may estimate the size of the second SDU to be transmitted to the modem.

At 1410, the UE 1402 may obtain an SR pattern and a first estimation of a delay between an SR associated with the second BSR and an uplink grant subsequent to the SR associated with the second BSR. In one aspect, the latency or delay between the arrival of the first SDU at the modem of the UE 1402 and the transmission of the first BSR and/or the first PDU may include a first latency component between the arrival time of the first SDU and the first available SR opportunity, and a second latency component between the first available SR opportunity and the transmission of the first BSR and/or the first PDU. The information associated with the second latency component of the latency may include the SR pattern and/or the SR to UL grant delay. Based on the SR pattern and/or the SR to UL grant delay, the application may align the second SDU to be as close as the PUSCH to reduce the latency. From the estimation of the arrival time of the second SDU, the BSR may be triggered so that the modem may transmit the SR in the closest opportunity that is ahead of the arrival time of the second SDU in the buffer.

At 1412, the UE 1402 may align the second arrival time based on the SR pattern and the first estimation of the delay. In some aspects, the modem of the UE 1402 may instruct (or configure) the application of the UE 1402 to align the SDU traffic based on the estimation of the second SDU. Here, the modem may report the timing information including the SR pattern and/or the delay between the SR and the UE 1402 grant to the application through a cross-layer API. The application may align the delivery of the future SDUs based on the timing information received from the modem to reduce the latency. For example, the delivery of the future SDUs (e.g., the second SDU) may be aligned considering the time for the modem to build the MAC PDU of the second PDU based on the second SDU.

The modem of the UE 1402 may report the information associated with the second latency component of the latency to the application, and instruct the application to align the second SDU to reduce the latency. Here, the information associated with the second latency component of the latency may include the SR pattern and/or the SR to UL grant delay. Based on the SR pattern and/or the SR to UL grant delay 713, the application may align the second SDU to be as close as the PUSCH to reduce the latency. From the estimation of the arrival time of the next SDU (e.g., the second SDU), the BSR may be triggered so that the modem may transmit the second SR in the closest opportunity that is ahead of the arrival time of the second SDU in the buffer.

In some aspects, multiple SDUs may be delivered to the modem of the UE 1402 by the application of the UE 1402 in between two consecutive SR opportunities. For example, a first SDU and a third SDU may arrive in the buffer of the modem of the UE 1402, and the UE 1402 may estimate a second SDU and a fourth SDU in the future based on the first SDU and the third SDU. Here, the second SDU and the fourth SDU may be associated with the same data flow or different data flows. At 1414, the UE 1402 may obtain a fourth estimation of a fourth SDU based on a third SDU with a third arrival time at the modem of the UE 1402, the fourth estimation including a fourth arrival time when the fourth SDU is estimated to arrive at the modem of the UE 1402 after the third arrival time, and the second SDU being different from the fourth SDU. The estimation of the second SDU may be done by the application or the modem of the UE 1402. The estimation may be based on a configuration or a AI/ML model. In one aspect the estimation may be configured for the UE 1402. Here, the second SDU and the fourth SDU may be associated with different flows. The estimation of the fourth SDU may further include an estimated size of the fourth SDU based on a size of the third SDU.

At 1416, the UE 1402 may initiate a transmission of a second BSR of the second SDU based on the estimation of the second SDU. In one aspect, the transmission of the second BSR is initiated based on no uplink grant being received after the second arrival time and before a subsequent SR opportunity. In one aspect, the SDU of the UE 1402 may arrive in the buffer of the modem of the UE 1402 after an SR opportunity, and end up waiting or holding the transmission of the SDU until the next SR opportunity.

At 1418, the UE 1402 may transmit an SR prior to the second arrival time. The network node 1404 may receive the SR prior to the second arrival time. Here, based on the estimation of the second SDU, the UE 1402 may transmit the SR to request the UL grant for sending the second BSR to the network node 1404. The network node 1404 may transmit the UL grant, based on the SR received at the SR opportunity, to the UE 1402, the UL grant indicating the UL resource for the UE 1402 to transmit the second BSR indicating the estimation of the second SDU. Based on the SR, the network node 1404 may transmit the UL grant dedicated for transmitting the second BSR at 1420.

At 1420, the network node 1404 may transmit an uplink grant based on the SR. The UE 1402 may receive the uplink grant based on the SR. The network node 1404 may configure the UL configured grants that may be dedicated to transmitting the second BSR. That is, the network node 1404 may configure a UL configured grant for the UE 1402, and the UL configured grant may indicate the schedule of the UL slots for the UE 1402 to transmit the second BSR based on the estimation of the second SDU.

In one example, the uplink grant may be a configuration of at least one dedicated configured grant for transmitting the second BSR of the second SDU based on the estimation of the second SDU. In another example, the second BSR may be transmitted based on the uplink grant prior to the second arrival time.

At 1422, the UE 1402 may transmit the second BSR to the network node 1404. The network node 1404 may receive at least one BSR indicating at least one target PUSCH from a UE 1402, the at least one BSR including the second BSR based on an estimation of a second SDU including a second arrival time of the second SDU at a modem of the UE 1402, the estimation of the second SDU being based on at least one first SDU with a first arrival time at the modem of the UE 1402, the second arrival time being after the first arrival time.

The second BSR may include or indicate at least one of the size (e.g., the estimated size) of the second SDU or the slot for transmitting the target PUSCH including the data of the second SDU based on the estimated arrival time of the second SDU.

In one aspect, the second BSR of the second SDU may be transmitted via an uplink configured grant based on the second SDU not being received at the modem of the UE 1402 before the uplink configured grant, and the second BSR of the second SDU may be transmitted via an uplink configured grant based on the second SDU not being received at the modem of the UE 1402 before the uplink configured grant. That is, if the second SDU has not arrived yet in the buffer, the UE 1402 may transmit the second BSR with a dedicated format to report the expected size (if available) of the second BSR and the time when the target PUSCH may be transmitted to deliver the second BSR and/or the second PDU of the second SDU. In another aspect, the second BSR may be transmitted in a PUSCH transmitting the at least one first SDU.

Based on the second BSR including or indicating the at least one of the size (e.g., the estimated size) of the second SDU or the time slot for transmitting the target PUSCH including the data of the second SDU, the network node 1404 may transmit the UL grant configuring the target PUSCH for the UE 1402 to transmit the second PDU carrying the data of the second SDU.

The second BSR of the second SDU may include an indication of a plurality of target PUSCHs, and where the second SDU is transmitted in at least one of the plurality of target PUSCHs. In one aspect, based on the multiple SDUs may be delivered to the modem of the UE 1402 by the application of the UE 1402 in between two consecutive SR opportunities, the second BSR may include the indication of multiple target PUSCHs. In one example, the second BSR may include the estimation of the second SDU and the fourth SDU.

In another example, the BSR may include the indication of the estimation about the second SDU, and the indication of the estimation about the fourth SDU may be transmitted at 1424 with the second PDU based on the second SDU. Based on indicating the estimation about the fourth SDU with the second PDU, the second BSR may indicate a size of the fourth BSR to be included in the second target PUSCH. That is, the second BSR may indicate the size of the second SDU and the size of the size of the fourth BSR, and the network node 1404 may transmit the UL grant to schedule the second target PUSCH for transmitting the second PDU of the second SDU and the fourth BSR associated with the fourth SDU.

At 1424, the UE 1402 may transmit the second PDU based on the second BSR via the target PUSCH. The network node 1404 may receive the second SDU in the at least one target PUSCH. In one aspect, a fourth BSR of the fourth SDU based on the fourth estimation may be transmitted with the second PDU, the fourth BSR being included in a second target PUSCH to transmit the second SDU based on the second BSR. In one aspect, a fourth BSR of the fourth SDU based on the fourth estimation, the fourth BSR being included in a second target PUSCH to transmit the second SDU based on the second BSR.

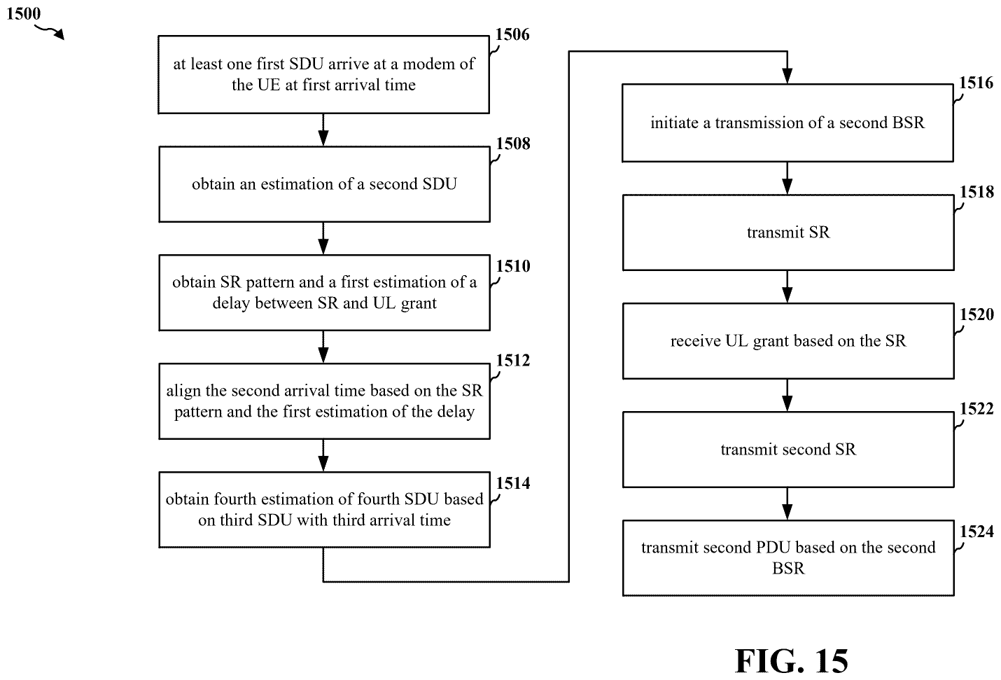

FIG. 15 is a flowchart 1500 of a method of wireless communication. The method may be performed by a UE (e.g., the UE 104/402/502/602/702/802/902/1002/1102/1202/1302/1402; the apparatus 1904). The UE may be configured to obtain one or more estimations of one or more future SDUs based on one or more past SDUs and initiate a transmission of one or more BSR of the one or more future SDUs based on the one or more estimations of one or more future SDUs. The one or more estimations may include estimated arrival times of the one or more future SDUs and estimated size of the one or more future SDUs.

At 1506, at least one first SDU may arrive at a modem of the UE at a first arrival time. In one aspect, an arrival of a SDU in an empty buffer of the modem may trigger a transmission of an SR and the BSR. For example, at 1406, the UE 1402, at least one first SDU may arrive at a modem of the UE 1402 at a first arrival time. Furthermore, 1506 may be performed by a BSR component 198.

At 1508, the UE may obtain an estimation of a second SDU based on at least one first SDU with a first arrival time at a modem of the UE, the estimation of the second SDU including a second arrival time at the modem of the UE, the second arrival time being after the first arrival time. The estimation of the second SDU may be done by the application or the modem of the UE. For example, at 1408, the UE 1402 may obtain an estimation of a second SDU based on at least one first SDU with a first arrival time at a modem of the UE 1402, the estimation of the second SDU including a second arrival time at the modem of the UE 1402, the second arrival time being after the first arrival time. Furthermore, 1508 may be performed by the BSR component 198.

In one aspect, the estimation may be based on a configuration or a AI/ML model. In one aspect the estimation may be configured for the UE. In one example, based on a category or at least one property of the first SDU, the application or the modem of the UE may be configured to estimate the arrival time and/or the size of the second SDU based on the first SDU. In another example, the application or the modem of the UE may include the AI/ML model for estimating the future SDU, and the application or the modem of the UE may estimate the arrival time and/or the size of the second SDU based on the first SDU using the AI/ML model.

In another aspect, the estimation of the arrival time of the second SDU may include the estimation of the jitter associated with the second SDU. That is, the UE may be configured to estimate the jitter associated with the second SDU and take the estimated jitter into account to determine the arrival time of the second SDU. Based on the estimated arrival time of the second SDU, the UE may schedule or configure the target PUSCH to transmit the PDU including the data in the second SDU via the target PUSCH.

The estimation of the second SDU may further include an estimated size of the second SDU based on a size of the at least one first SDU. That is, in addition to the arrival time, the size of the second SDU may also be estimated. That is, based on the size of the first SDU received in the buffer of the modem, the modem may estimate the size of the second SDU to be received from the application. Also, based on the size of the SDU transmitted to the modem, the application may estimate the size of the second SDU to be transmitted to the modem.

At 1510, the UE may obtain an SR pattern and a first estimation of a delay between an SR associated with the second BSR and an uplink grant subsequent to the SR associated with the second BSR. In one aspect, the latency or delay between the arrival of the first SDU at the modem of the UE and the transmission of the first BSR and/or the first PDU may include a first latency component between the arrival time of the first SDU and the first available SR opportunity, and a second latency component between the first available SR opportunity and the transmission of the first BSR and/or the first PDU. The information associated with the second latency component of the latency may include the SR pattern and/or the SR to UL grant delay. Based on the SR pattern and/or the SR to UL grant delay, the application may align the second SDU to be as close as the PUSCH to reduce the latency. From the estimation of the arrival time of the second SDU, the BSR may be triggered so that the modem may transmit the SR in the closest opportunity that is ahead of the arrival time of the second SDU in the buffer. For example, at, the UE may obtain an SR pattern and a first estimation of a delay between an SR associated with the second BSR and an uplink grant subsequent to the SR associated with the second BSR. Furthermore, 1510 may be performed by the BSR component 198.

At 1512, the UE may align the second arrival time based on the SR pattern and the first estimation of the delay. In some aspects, the modem of the UE may instruct (or configure) the application of the UE to align the SDU traffic based on the estimation of the second SDU. Here, the modem may report the timing information including the SR pattern and/or the delay between the SR and the UE grant to the application through a cross-layer API. The application may align the delivery of the future SDUs based on the timing information received from the modem to reduce the latency. For example, the delivery of the future SDUs (e.g., the second SDU) may be aligned considering the time for the modem to build the MAC PDU of the second PDU based on the second SDU. For example, at 1412, the UE 1402 may align the second arrival time based on the SR pattern and the first estimation of the delay. Furthermore, 1512 may be performed by the BSR component 198.

The modem of the UE may report the information associated with the second latency component of the latency to the application, and instruct the application to align the second SDU to reduce the latency. Here, the information associated with the second latency component of the latency may include the SR pattern and/or the SR to UL grant delay. Based on the SR pattern and/or the SR to UL grant delay 713, the application may align the second SDU to be as close as the PUSCH to reduce the latency. From the estimation of the arrival time of the next SDU (e.g., the second SDU), the BSR may be triggered so that the modem may transmit the second SR in the closest opportunity that is ahead of the arrival time of the SDU2 714 in the buffer.

In some aspects, multiple SDUs may be delivered to the modem of the UE by the application of the UE in between two consecutive SR opportunities. For example, a first SDU and a third SDU may arrive in the buffer of the modem of the UE, and the UE may estimate a second SDU and a fourth SDU in the future based on the first SDU and the third SDU. Here, the second SDU and the fourth SDU may be associated with the same data flow or different data flows.

At 1514, the UE may obtain a fourth estimation of a fourth SDU based on a third SDU with a third arrival time at the modem of the UE, the fourth estimation including a fourth arrival time when the fourth SDU is estimated to arrive at the modem of the UE after the third arrival time, and the second SDU being different from the fourth SDU. The estimation of the second SDU may be done by the application or the modem of the UE. The estimation may be based on a configuration or a AI/ML model. In one aspect the estimation may be configured for the UE. Here, the second SDU and the fourth SDU may be associated with different flows. The estimation of the fourth SDU may further include an estimated size of the fourth SDU based on a size of the third SDU. For example, at 1514, the UE may obtain a fourth estimation of a fourth SDU based on a third SDU with a third arrival time at the modem of the UE, the fourth estimation including a fourth arrival time when the fourth SDU is estimated to arrive at the modem of the UE after the third arrival time, and the second SDU being different from the fourth SDU. Furthermore, 1514 may be performed by the BSR component 198.

At 1516, the UE may initiate a transmission of a second BSR of the second SDU based on the estimation of the second SDU. In one aspect, the transmission of the second BSR is initiated based on no uplink grant being received after the second arrival time and before a subsequent SR opportunity. In one aspect, the SDU of the UE may arrive in the buffer of the modem of the UE after an SR opportunity, and end up waiting or holding the transmission of the SDU until the next SR opportunity. For example, at 1416, the UE 1402 may initiate a transmission of a second BSR of the second SDU based on the estimation of the second SDU. Furthermore, 1516 may be performed by a BSR component 198.

At 1518, the UE may transmit an SR prior to the second arrival time. Here, based on the estimation of the second SDU, the UE may transmit the SR to request the UL grant for sending the second BSR to the network node. The network node may transmit the UL grant, based on the SR received at the SR opportunity, to the UE, the UL grant indicating the UL resource for the UE to transmit the second BSR indicating the estimation of the second SDU. Based on the SR, the network node may transmit the UL grant dedicated for transmitting the second BSR at. For example, at, the UE may transmit an SR prior to the second arrival time. Furthermore, 1518 may be performed by the BSR component 198.

At 1520, the UE may receive the uplink grant based on the SR. That is, the network node may configure a UL configured grant for the UE, and the UL configured grant may indicate the schedule of the UL slots for the UE to transmit the second BSR based on the estimation of the second SDU. In one example, the uplink grant may be a configuration of at least one dedicated configured grant for transmitting the second BSR of the second SDU based on the estimation of the second SDU. In another example, the second BSR may be transmitted based on the uplink grant prior to the second arrival time. For example, at 1420, the UE 1402 may receive the uplink grant based on the SR. Furthermore, 1520 may be performed by the BSR component 198.

At 1522, the UE may transmit the second BSR to the network node. For example, at, the UE may transmit the second BSR to the network node. Furthermore, 1522 may be performed by the BSR component 198.

At 1524, the UE may transmit the second PDU based on the second BSR via the target PUSCH. In one aspect, a fourth BSR of the fourth SDU based on the fourth estimation may be transmitted with the second PDU, the fourth BSR being included in a second target PUSCH to transmit the second SDU based on the second BSR. In one aspect, a fourth BSR of the fourth SDU based on the fourth estimation, the fourth BSR being included in a second target PUSCH to transmit the second SDU based on the second BSR. For example, at 1524, the UE 1402 may transmit the second PDU based on the second BSR via the target PUSCH. Furthermore, 1524 may be performed by the BSR component 198.

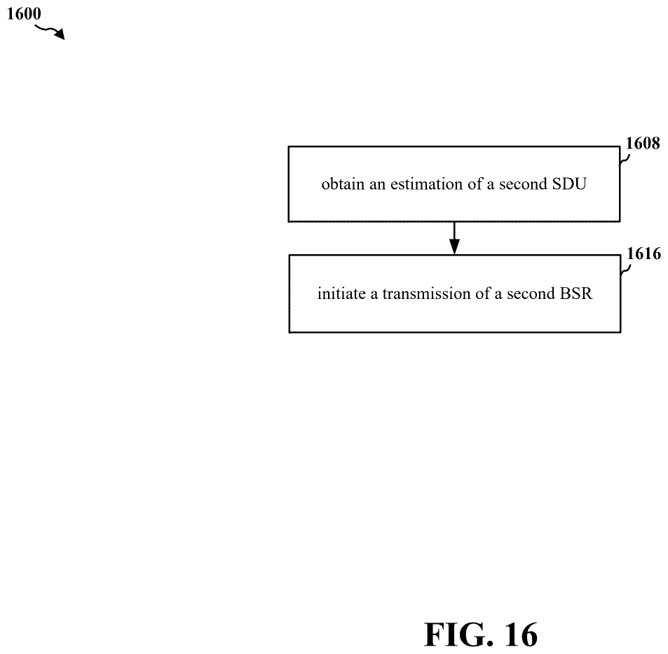

FIG. 16 is a flowchart 1600 of a method of wireless communication. The method may be performed by a UE (e.g., the UE 104/402/502/602/702/802/902/1002/1102/1202/1302/1402; the apparatus 1904). The UE may be configured to obtain one or more estimations of one or more future SDUs based on one or more past SDUs and initiate a transmission of one or more BSR of the one or more future SDUs based on the one or more estimations of one or more future SDUs. The one or more estimations may include estimated arrival times of the one or more future SDUs and estimated size of the one or more future SDUs.

At 1608, the UE may obtain an estimation of a second SDU based on at least one first SDU with a first arrival time at a modem of the UE, the estimation of the second SDU including a second arrival time at the modem of the UE, the second arrival time being after the first arrival time. The estimation of the second SDU may be done by the application or the modem of the UE. For example, at 1408, the UE 1402 may obtain an estimation of a second SDU based on at least one first SDU with a first arrival time at a modem of the UE 1402, the estimation of the second SDU including a second arrival time at the modem of the UE 1402, the second arrival time being after the first arrival time. Furthermore, 1608 may be performed by the BSR component 198.

In one aspect, the estimation may be based on a configuration or a AI/ML model. In one aspect the estimation may be configured for the UE. In one example, based on a category or at least one property of the first SDU, the application or the modem of the UE may be configured to estimate the arrival time and/or the size of the second SDU based on the first SDU. In another example, the application or the modem of the UE may include the AI/ML model for estimating the future SDU, and the application or the modem of the UE may estimate the arrival time and/or the size of the second SDU based on the first SDU using the AI/ML model.

In another aspect, the estimation of the arrival time of the second SDU may include the estimation of the jitter associated with the second SDU. That is, the UE may be configured to estimate the jitter associated with the second SDU and take the estimated jitter into account to determine the arrival time of the second SDU. Based on the estimated arrival time of the second SDU, the UE may schedule or configure the target PUSCH to transmit the PDU including the data in the second SDU via the target PUSCH.

The estimation of the second SDU may further include an estimated size of the second SDU based on a size of the at least one first SDU. That is, in addition to the arrival time, the size of the second SDU may also be estimated. That is, based on the size of the first SDU received in the buffer of the modem, the modem may estimate the size of the second SDU to be received from the application. Also, based on the size of the SDU transmitted to the modem, the application may estimate the size of the second SDU to be transmitted to the modem.

At 1616, the UE may initiate a transmission of a second BSR of the second SDU based on the estimation of the second SDU. In one aspect, the transmission of the second BSR is initiated based on no uplink grant being received after the second arrival time and before a subsequent SR opportunity. In one aspect, the SDU of the UE may arrive in the buffer of the modem of the UE after an SR opportunity, and end up waiting or holding the transmission of the SDU until the next SR opportunity. For example, at 1416, the UE 1402 may initiate a transmission of a second BSR of the second SDU based on the estimation of the second SDU. Furthermore, 1616 may be performed by a BSR component 198.

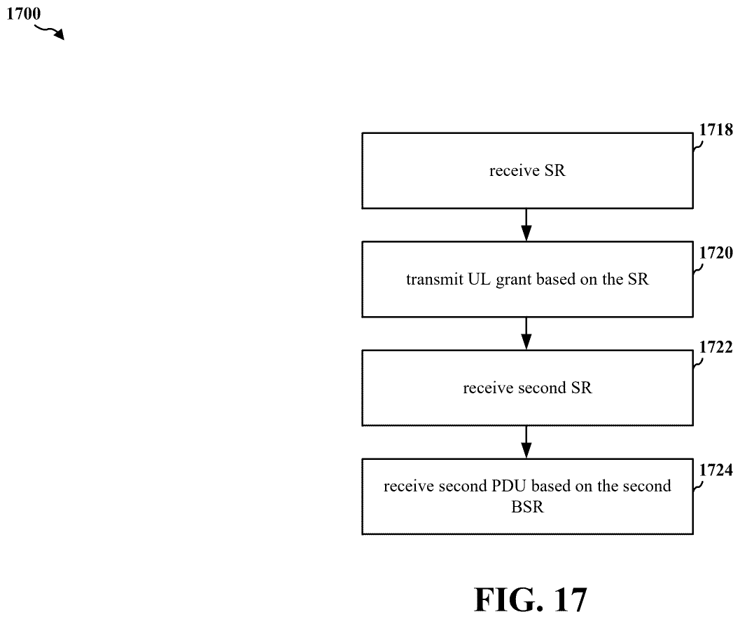

FIG. 17 is a flowchart 1700 of a method of wireless communication. The method may be performed by a network node (e.g., the base station 102; network node 1404; the network entity 2002). Based on the BSR, the network node may configure UL grant for the UE to transmit the one or more BSR and one or more PDUs carrying the data of the one or more SDUs.

At 1718, the network node may receive the SR prior to the second arrival time. Here, based on the estimation of the second SDU, the UE may transmit the SR to request the UL grant for sending the second BSR to the network node. The network node may transmit the UL grant, based on the SR received at the SR opportunity, to the UE, the UL grant indicating the UL resource for the UE to transmit the second BSR indicating the estimation of the second SDU. Based on the SR, the network node may transmit the UL grant dedicated for transmitting the second BSR. For example, at, the network node may receive the SR prior to the second arrival time. Furthermore, 1718 may be performed by the UL grant component 199.

At 1720, the network node may transmit an uplink grant based on the SR. The network node may configure the UL configured grants that may be dedicated to transmitting the second BSR. That is, the network node may configure a UL configured grant for the UE, and the UL configured grant may indicate the schedule of the UL slots for the UE to transmit the second BSR based on the estimation of the second SDU. In one example, the uplink grant may be a configuration of at least one dedicated configured grant for transmitting the second BSR of the second SDU based on the estimation of the second SDU. In another example, the second BSR may be transmitted based on the uplink grant prior to the second arrival time. For example, at 1420, the network node may transmit an uplink grant based on the SR. Furthermore, 1720 may be performed by the UL grant component 199.

At 1722, the network node may receive at least one BSR indicating at least one target PUSCH from a UE, the at least one BSR including the second BSR based on an estimation of a second SDU including a second arrival time of the second SDU at a modem of the UE. the estimation of the second SDU being based on at least one first SDU with a first arrival time at the modem of the UE, the second arrival time being after the first arrival time. For example, at 1422, the network node 1404 may receive at least one BSR indicating at least one target PUSCH from a UE 1402, the at least one BSR including the second BSR based on an estimation of a second SDU including a second arrival time of the second SDU at a modem of the UE 1402. Furthermore, 1722 may be performed by the UL grant component 199.

The second BSR may include or indicate at least one of the size (e.g., the estimated size) of the second SDU or the slot for transmitting the target PUSCH including the data of the second SDU based on the estimated arrival time of the second SDU.

In one aspect, the second BSR of the second SDU may be transmitted via an uplink configured grant based on the second SDU not being received at the modem of the UE before the uplink configured grant, and the second BSR of the second SDU may be transmitted via an uplink configured grant based on the second SDU not being received at the modem of the UE before the uplink configured grant. That is, if the second SDU has not arrived yet in the buffer, the UE may transmit the second BSR with a dedicated format to report the expected size (if available) of the second BSR and the time when the target PUSCH may be transmitted to deliver the second BSR and/or the second PDU of the second SDU. In another aspect, the second BSR may be transmitted in a PUSCH transmitting the at least one first SDU.

Based on the second BSR including or indicating the at least one of the size (e.g., the estimated size) of the second SDU or the time slot for transmitting the target PUSCH including the data of the second SDU, the network node may transmit the UL grant configuring the target PUSCH for the UE to transmit the second PDU carrying the data of the second SDU.

The second BSR of the second SDU may include an indication of a plurality of target PUSCHs, and where the second SDU is transmitted in at least one of the plurality of target PUSCHs. In one aspect, based on the multiple SDUs may be delivered to the modem of the UE by the application of the UE in between two consecutive SR opportunities, the second BSR may include the indication of multiple target PUSCHs. In one example, the second BSR may include the estimation of the second SDU and the fourth SDU.

In another example, the BSR may include the indication of the estimation about the second SDU, and the indication of the estimation about the fourth SDU may be transmitted with the second PDU based on the second SDU. Based on indicating the estimation about the fourth SDU with the second PDU, the second BSR may indicate a size of the fourth BSR to be included in the second target PUSCH. That is, the second BSR may indicate the size of the second SDU and the size of the size of the fourth BSR, and the network node may transmit the UL grant to schedule the second target PUSCH for transmitting the second PDU of the second SDU and the fourth BSR associated with the fourth SDU.

At 1724, the network node may receive the second SDU in the at least one target PUSCH. In one aspect, a fourth BSR of the fourth SDU based on the fourth estimation may be transmitted with the second PDU, the fourth BSR being included in a second target PUSCH to transmit the second SDU based on the second BSR. In one aspect, a fourth BSR of the fourth SDU based on the fourth estimation, the fourth BSR being included in a second target PUSCH to transmit the second SDU based on the second BSR. For example, at 1424, the network node 1404 may receive the second SDU in the at least one target PUSCH. Furthermore, 1724 may be performed by the UL grant component 199.

Based on the BSR, the network node may configure UL grant for the UE to transmit the one or more BSR and one or more PDUs carrying the data of the one or more SDUs.

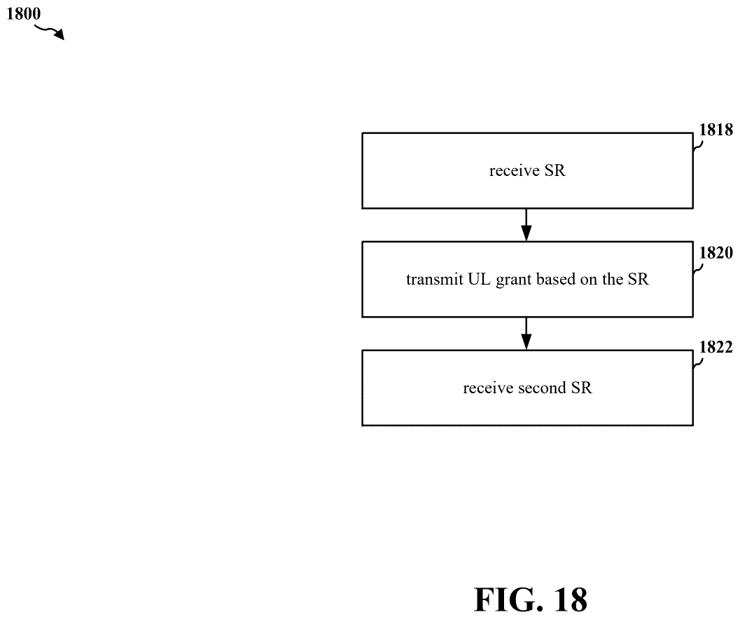

FIG. 18 is a flowchart 1800 of a method of wireless communication. The method may be performed by a network node (e.g., the base station 102; network node 1404; the network entity 2002). Based on the BSR, the network node may configure UL grant for the UE to transmit the one or more BSR and one or more PDUs carrying the data of the one or more SDUs.

At 1818, the network node may receive the SR prior to the second arrival time. Here, based on the estimation of the second SDU, the UE may transmit the SR to request the UL grant for sending the second BSR to the network node. The network node may transmit the UL grant, based on the SR received at the SR opportunity, to the UE, the UL grant indicating the UL resource for the UE to transmit the second BSR indicating the estimation of the second SDU. Based on the SR, the network node may transmit the UL grant dedicated for transmitting the second BSR. For example, at, the network node may receive the SR prior to the second arrival time. Furthermore, 1818 may be performed by the UL grant component 199.

At 1820, the network node may transmit an uplink grant based on the SR. The network node may configure the UL configured grants that may be dedicated to transmitting the second BSR. That is, the network node may configure a UL configured grant for the UE, and the UL configured grant may indicate the schedule of the UL slots for the UE to transmit the second BSR based on the estimation of the second SDU. In one example, the uplink grant may be a configuration of at least one dedicated configured grant for transmitting the second BSR of the second SDU based on the estimation of the second SDU. In another example, the second BSR may be transmitted based on the uplink grant prior to the second arrival time. For example, at 1420, the network node may transmit an uplink grant based on the SR. Furthermore, 1820 may be performed by the UL grant component 199.

At 1822, the network node may receive at least one BSR indicating at least one target PUSCH from a UE, the at least one BSR including the second BSR based on an estimation of a second SDU including a second arrival time of the second SDU at a modem of the UE. the estimation of the second SDU being based on at least one first SDU with a first arrival time at the modem of the UE, the second arrival time being after the first arrival time. For example, at 1422, the network node 1404 may receive at least one BSR indicating at least one target PUSCH from a UE 1402, the at least one BSR including the second BSR based on an estimation of a second SDU including a second arrival time of the second SDU at a modem of the UE 1402. Furthermore, 1822 may be performed by the UL grant component 199.

The second BSR may include or indicate at least one of the size (e.g., the estimated size) of the second SDU or the slot for transmitting the target PUSCH including the data of the second SDU based on the estimated arrival time of the second SDU.

In one aspect, the second BSR of the second SDU may be transmitted via an uplink configured grant based on the second SDU not being received at the modem of the UE before the uplink configured grant, and the second BSR of the second SDU may be transmitted via an uplink configured grant based on the second SDU not being received at the modem of the UE before the uplink configured grant. That is, if the second SDU has not arrived yet in the buffer, the UE may transmit the second BSR with a dedicated format to report the expected size (if available) of the second BSR and the time when the target PUSCH may be transmitted to deliver the second BSR and/or the second PDU of the second SDU. In another aspect, the second BSR may be transmitted in a PUSCH transmitting the at least one first SDU.

Based on the second BSR including or indicating the at least one of the size (e.g., the estimated size) of the second SDU or the time slot for transmitting the target PUSCH including the data of the second SDU, the network node may transmit the UL grant configuring the target PUSCH for the UE to transmit the second PDU carrying the data of the second SDU.

The second BSR of the second SDU may include an indication of a plurality of target PUSCHs, and where the second SDU is transmitted in at least one of the plurality of target PUSCHs. In one aspect, based on the multiple SDUs may be delivered to the modem of the UE by the application of the UE in between two consecutive SR opportunities, the second BSR may include the indication of multiple target PUSCHs. In one example, the second BSR may include the estimation of the second SDU and the fourth SDU.

In another example, the BSR may include the indication of the estimation about the second SDU, and the indication of the estimation about the fourth SDU may be transmitted with the second PDU based on the second SDU. Based on indicating the estimation about the fourth SDU with the second PDU, the second BSR may indicate a size of the fourth BSR to be included in the second target PUSCH. That is, the second BSR may indicate the size of the second SDU and the size of the size of the fourth BSR, and the network node may transmit the UL grant to schedule the second target PUSCH for transmitting the second PDU of the second SDU and the fourth BSR associated with the fourth SDU.

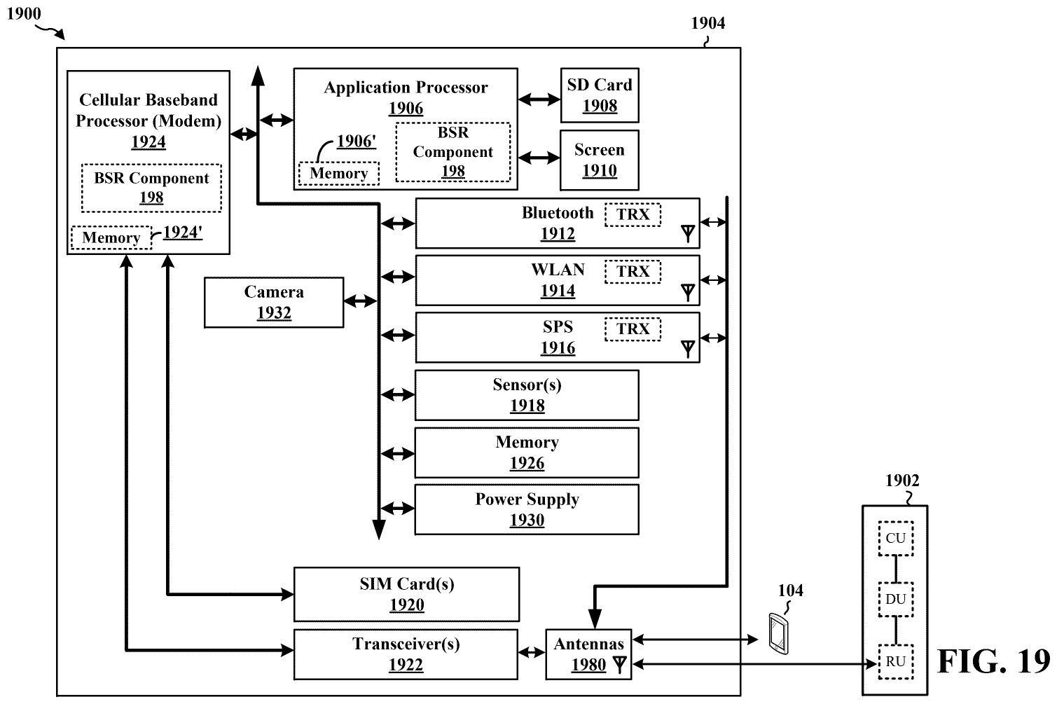

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the component 198 is configured to obtain an estimation of a second SDU based on at least one first SDU with a first arrival time at a modem of the UE, the estimation of the second SDU including a second arrival time at the modem of the UE, the second arrival time being after the first arrival time, and initiate a transmission of a second BSR of the second SDU based on the estimation of the second SDU. The component 198 may be within the cellular baseband processor 1924, the application processor 1906, or both the cellular baseband processor 1924 and the application processor 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for obtaining an estimation of a second SDU based on at least one first SDU with a first arrival time at a modem of the UE, the estimation of the second SDU including a second arrival time at the modem of the UE, the second arrival time being after the first arrival time, and means for initiating a transmission of a second BSR of the second SDU based on the estimation of the second SDU. In one configuration, the estimation of the second SDU further includes an estimated size of the second SDU based on a size of the at least one first SDU. In one configuration, the transmission of the second BSR is initiated based on no uplink grant being received after the second arrival time and before a subsequent SR opportunity. In one configuration, the apparatus 1904, and in particular the cellular baseband processor 1924 and/or the application processor 1906, further includes means for receiving a configuration of at least one dedicated configured grant for transmitting the second BSR of the second SDU based on the estimation of the second SDU. In one configuration, the apparatus 1904, and in particular the cellular baseband processor 1924 and/or the application processor 1906, further includes means for obtaining an SR pattern and a first estimation of a delay between an SR associated with the BSR and an uplink grant subsequent to the SR associated with the BSR. In one configuration, the apparatus 1904, and in particular the cellular baseband processor 1924 and/or the application processor 1906, further includes means for aligning the second arrival time based on the SR pattern and the first estimation of the delay. In one configuration, the SR associated with the BSR is transmitted in an available SR opportunity that is closest and prior to the second arrival time. In one configuration, the BSR indicates a transmission time of a target PUSCH to transmit the second SDU. In one configuration, the apparatus 1904, and in particular the cellular baseband processor 1924 and/or the application processor 1906, further includes means for transmitting an SR prior to the second arrival time, and means for receiving an uplink grant based on the SR, where the second BSR is transmitted based on the uplink grant prior to the second arrival time. In one configuration, the transmission time of the target PUSCH is indicated in reference to the transmission of the BSR. In one configuration, the BSR indicates an estimated size of the second SDU based on the at least one first SDU. In one configuration, the apparatus 1904, and in particular the cellular baseband processor 1924 and/or the application processor 1906, further includes means for obtaining a fourth estimation of a fourth SDU based on a third SDU with a third arrival time at the modem of the UE, the fourth estimation including a fourth arrival time when the fourth SDU is estimated to arrive at the modem of the UE after the third arrival time, and the second SDU being different from the fourth SDU. In one configuration, the second BSR indicates the second arrival time and the fourth arrival time. In one configuration, the second BSR further indicates at least one of a second estimated size of the second SDU based on the at least one first SDU or a fourth estimated size of the fourth SDU based on the third SDU. In one configuration, the second SDU and the fourth SDU are associated with different flows. In one configuration, the apparatus 1904, and in particular the cellular baseband processor 1924 and/or the application processor 1906, further includes means for transmitting a fourth BSR of the fourth SDU based on the fourth estimation, the fourth BSR being included in a second target PUSCH to transmit the second SDU based on the second BSR. In one configuration, the second BSR indicates a size of the fourth BSR to be included in the second target PUSCH. In one configuration, the second BSR is transmitted in a PUSCH transmitting the at least one first SDU. In one configuration, the second BSR of the second SDU is transmitted via an uplink configured grant based on the second SDU not being received at the modem of the UE before the uplink configured grant, and the second SDU is transmitted in a second target PUSCH indicated by the second BSR. In one configuration, the second BSR of the second SDU includes an indication of a plurality of target PUSCHs, and where the second SDU is transmitted in at least one of the plurality of target PUSCHs. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

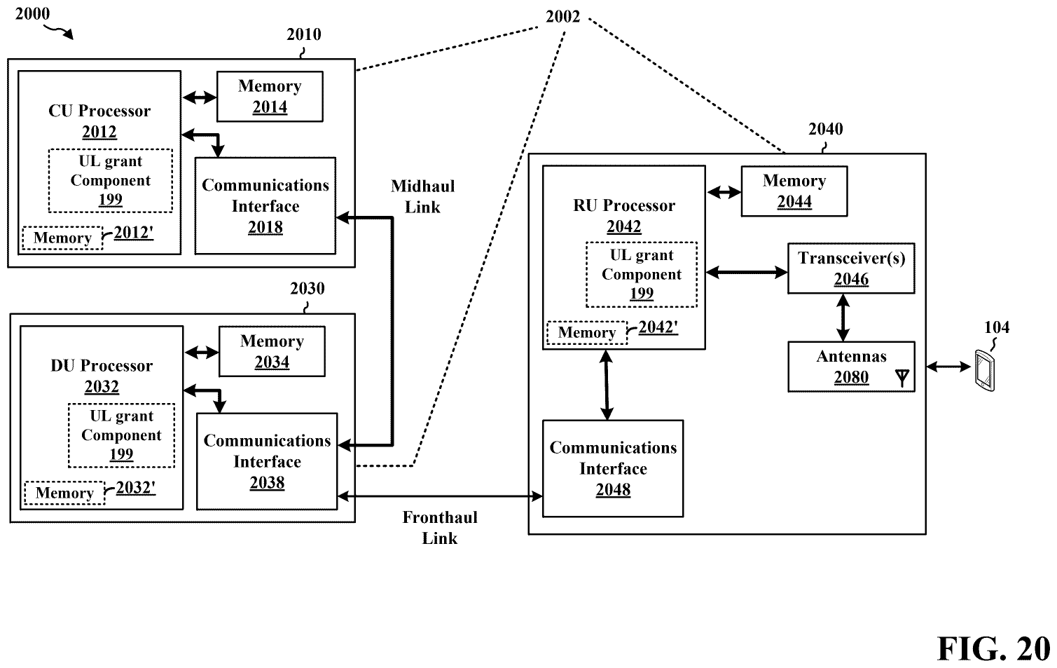

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive at least one BSR indicating at least one target PUSCH from a UE, the at least one BSR including a second BSR based on an estimation of a second SDU including a second arrival time of the second SDU at a modem of the UE, the estimation of the second SDU being based on at least one first SDU with a first arrival time at the modem of the UE, the second arrival time being after the first arrival time, transmit at least one uplink grant of the at least one target PUSCH based on the at least one BSR indicating the at least one target PUSCH, and receive the second SDU in the at least one target PUSCH. The component 199 may be within one or more processors of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for receiving at least one BSR indicating at least one target PUSCH from a UE, the at least one BSR including a second BSR based on an estimation of a second SDU including a second arrival time of the second SDU at a modem of the UE, the estimation of the second SDU being based on at least one first SDU with a first arrival time at the modem of the UE, the second arrival time being after the first arrival time, means for transmitting at least one uplink grant of the at least one target PUSCH based on the at least one BSR indicating the at least one target PUSCH, and means for receiving the second SDU in the at least one target PUSCH. In one configuration, the estimation of the second SDU further includes an estimated size of the second SDU based on a size of the at least one first SDU. In one configuration, the network entity 2002 further includes means for transmitting a configuration of at least one dedicated configured grant for transmitting the second BSR of the second SDU based on the estimation of the second SDU. In one configuration, the BSR indicates a transmission time of the at least one target PUSCH to transmit the second SDU. In one configuration, the network entity 2002 further includes means for receiving an SR prior to the second arrival time, and means for transmitting an uplink grant based on the SR, where the second BSR is received based on the uplink grant prior to the second arrival time. In one configuration, the transmission time of the target PUSCH is indicated in reference to the transmission of the BSR. In one configuration, the BSR indicates an estimated size of the second SDU based on the at least one first SDU. In one configuration, the network entity 2002 further includes means for receiving a fourth BSR of a fourth SDU from the UE, the fourth BSR based on an estimation of the fourth SDU including a fourth arrival time of the fourth SDU at the modem of the UE, where the estimation of the fourth SDU being based on at least one third SDU with a third arrival time at the modem of the UE, the fourth arrival time is after the third arrival time, and based on the fourth estimation, the fourth BSR is included in the at least one target PUSCH a second target PUSCH to transmit the second SDU based on the second BSR, and the second SDU is different from the fourth SDU. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of the current disclosure, the UE may obtain an estimation of a second SDU based on at least one first SDU with a first arrival time at a modem of the UE, the estimation of the second SDU including a second arrival time at the modem of the UE, the second arrival time being after the first arrival time, and initiate a transmission of a second BSR of the second SDU based on the estimation of the second SDU.

The network node may receive at least one BSR indicating at least one target PUSCH from a UE, the at least one BSR including a second BSR based on an estimation of a second SDU including a second arrival time of the second SDU at a modem of the UE, the estimation of the second SDU being based on at least one first SDU with a first arrival time at the modem of the UE, the second arrival time being after the first arrival time, transmit at least one uplink grant of the at least one target PUSCH based on the at least one BSR indicating the at least one target PUSCH, and receive the second SDU in the at least one target PUSCH.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising obtaining an estimation of a second SDU based on at least one first SDU with a first arrival time at a modem of the UE, the estimation of the second SDU including a second arrival time at the modem of the UE, the second arrival time being after the first arrival time, and initiating a transmission of a second BSR of the second SDU based on the estimation of the second SDU.

Aspect 2 is the method of aspect 1, where the estimation of the second SDU further includes an estimated size of the second SDU based on a size of the at least one first SDU.

Aspect 3 is the method of any of aspects 1 and 2, where the transmission of the second BSR is initiated based on no uplink grant being received after the second arrival time and before a subsequent SR opportunity.

Aspect 4 is the method of any of aspects 1 to 3, further including receiving a configuration of at least one dedicated configured grant for transmitting the second BSR of the second SDU based on the estimation of the second SDU.

Aspect 5 is the method of any of aspects 1 to 3, further including obtaining an SR pattern and a first estimation of a delay between an SR associated with the BSR and an uplink grant subsequent to the SR associated with the BSR.

Aspect 6 is the method of aspect 5, further including aligning the second arrival time based on the SR pattern and the first estimation of the delay.

Aspect 7 is the method of any of aspects 5 and 6, where the SR associated with the BSR is transmitted in an available SR opportunity that is closest and prior to the second arrival time.

Aspect 8 is the method of any of aspects 1 to 3, where the BSR indicates a transmission time of a target PUSCH to transmit the second SDU.

Aspect 9 is the method of aspect 8, further including transmitting an SR prior to the second arrival time, and receiving an uplink grant based on the SR, where the second BSR is transmitted based on the uplink grant prior to the second arrival time.

Aspect 10 is the method of any of aspects 8 and 9, where the transmission time of the target PUSCH is indicated in reference to the transmission of the BSR.

Aspect 11 is the method of any of aspects 8 to 10, where the BSR indicates an estimated size of the second SDU based on the at least one first SDU.

Aspect 12 is the method of any of aspects 1 to 3, further including obtaining a fourth estimation of a fourth SDU based on a third SDU with a third arrival time at the modem of the UE, the fourth estimation including a fourth arrival time when the fourth SDU is estimated to arrive at the modem of the UE after the third arrival time, and the second SDU being different from the fourth SDU.

Aspect 13 is the method of aspect 12, where the second BSR indicates the second arrival time and the fourth arrival time.

Aspect 14 is the method of any of aspects 12 and 13, where the second BSR further indicates at least one of a second estimated size of the second SDU based on the at least one first SDU or a fourth estimated size of the fourth SDU based on the third SDU.

Aspect 15 is the method of any of aspects 12 to 14, where the second SDU and the fourth SDU are associated with different flows.

Aspect 16 is the method of any of aspects 12 to 15, further including transmitting a fourth BSR of the fourth SDU based on the fourth estimation, the fourth BSR being included in a second target PUSCH to transmit the second SDU based on the second BSR.

Aspect 17 is the method of aspects 16, where the second BSR indicates a size of the fourth BSR to be included in the second target PUSCH.

Aspect 18 is the method of any of aspects 1 to 17, where the second BSR is transmitted in a PUSCH transmitting the at least one first SDU.

Aspect 19 is the method of any of aspects 1 to 18, where the second BSR of the second SDU is transmitted via an uplink configured grant based on the second SDU not being received at the modem of the UE before the uplink configured grant, and the second SDU is transmitted in a second target PUSCH indicated by the second BSR.

Aspect 20 is the method of any of aspects 1 to 19, where the second BSR of the second SDU includes an indication of a plurality of target PUSCHs, and where the second SDU is transmitted in at least one of the plurality of target PUSCHs.

Aspect 21 is an apparatus for wireless communication including at least one processor coupled to a memory and configured to implement any of aspects 1 to 20, further including a transceiver coupled to the at least one processor.

Aspect 22 is an apparatus for wireless communication including means for implementing any of aspects 1 to 20.

Aspect 23 is a non-transitory computer-readable medium storing computer executable code, where the code when executed by a processor causes the processor to implement any of aspects 1 to 20.

Aspect 24 is a method of wireless communication at a network node, including receiving at least one BSR indicating at least one target PUSCH from a UE, the at least one BSR including a second BSR based on an estimation of a second SDU including a second arrival time of the second SDU at a modem of the UE, the estimation of the second SDU being based on at least one first SDU with a first arrival time at the modem of the UE, the second arrival time being after the first arrival time, transmitting at least one uplink grant of the at least one target PUSCH based on the at least one BSR indicating the at least one target PUSCH, and receiving the second SDU in the at least one target PUSCH.

Aspect 25 is the method of aspect 24, where the estimation of the second SDU further includes an estimated size of the second SDU based on a size of the at least one first SDU.

Aspect 26 is the method of any of aspects 24 and 25, further including transmitting a configuration of at least one dedicated configured grant for transmitting the second BSR of the second SDU based on the estimation of the second SDU.

Aspect 27 is the method of any of aspects 24 to 26, where the BSR indicates a transmission time of the at least one target PUSCH to transmit the second SDU.

Aspect 28 is the method of aspect 27, further including receiving an SR prior to the second arrival time, and transmitting an uplink grant based on the SR, where the second BSR is received based on the uplink grant prior to the second arrival time.

Aspect 29 is the method of any of aspects 27 and 28, where the transmission time of the target PUSCH is indicated in reference to the transmission of the BSR.

Aspect 30 is the method of any of aspects 27 to 29, where the BSR indicates an estimated size of the second SDU based on the at least one first SDU.

Aspect 31 is the method of any of aspects 24 to 30, further including receiving a fourth BSR of a fourth SDU from the UE, the fourth BSR based on an estimation of the fourth SDU including a fourth arrival time of the fourth SDU at the modem of the UE, where the estimation of the fourth SDU being based on at least one third SDU with a third arrival time at the modem of the UE, the fourth arrival time is after the third arrival time, and based on the fourth estimation, the fourth BSR is included in the at least one target PUSCH a second target PUSCH to transmit the second SDU based on the second BSR, and the second SDU is different from the fourth SDU.

Aspect 32 is an apparatus for wireless communication including at least one processor coupled to a memory and configured to implement any of aspects 24 to 31, further including a transceiver coupled to the at least one processor.

Aspect 33 is an apparatus for wireless communication including means for implementing any of aspects 24 to 31.

Aspect 34 is a non-transitory computer-readable medium storing computer executable code, where the code when executed by a processor causes the processor to implement any of aspects 24 to 31.

What is claimed is:

1. An apparatus for wireless communication at a user equipment (UE), comprising:
a memory; and
at least one processor coupled to the memory and, based at least in part on information stored in the memory, the at least one processor is configured to:
obtain an estimation of a second service data unit (SDU) based on at least one first SDU with a first arrival time at a modem of the UE, the estimation of the second SDU comprising a second arrival time at the modem of the UE, the second arrival time being after the first arrival time; and
initiate a transmission of a second buffer status report (BSR) of the second SDU based on the estimation of the second SDU.

2. The apparatus of claim 1, wherein the estimation of the second SDU further comprises an estimated size of the second SDU based on a size of the at least one first SDU.

3. The apparatus of claim 1, wherein the transmission of the second BSR is initiated based on no uplink grant being received after the second arrival time and before a subsequent scheduling request (SR) opportunity.

4. The apparatus of claim 1, wherein the at least one processor is further configured to:
receive a configuration of at least one dedicated configured grant for transmitting the second BSR of the second SDU based on the estimation of the second SDU.

5. The apparatus of claim 1, wherein the at least one processor is further configured to:
obtain a scheduling request (SR) pattern and a first estimation of a delay between an SR associated with the BSR and an uplink grant subsequent to the SR associated with the BSR.

6. The apparatus of claim 5, wherein the at least one processor is further configured to:
align the second arrival time based on the SR pattern and the first estimation of the delay.

7. The apparatus of claim 5, wherein the SR associated with the BSR is transmitted in an available SR opportunity that is closest and prior to the second arrival time.

8. The apparatus of claim 1, wherein the BSR indicates a transmission time of a target physical uplink shared channel (PUSCH) to transmit the second SDU.

9. The apparatus of claim 8, wherein the at least one processor is further configured to:
transmit a scheduling request (SR) prior to the second arrival time; and
receive an uplink grant based on the SR,
wherein the second BSR is transmitted based on the uplink grant prior to the second arrival time.

10. The apparatus of claim 8, wherein the transmission time of the target PUSCH is indicated in reference to the transmission of the BSR.

11. The apparatus of claim 8, wherein the BSR indicates an estimated size of the second SDU based on the at least one first SDU.

12. The apparatus of claim 1, wherein the at least one processor is further configured to:
obtain a fourth estimation of a fourth SDU based on a third SDU with a third arrival time at the modem of the UE, the fourth estimation comprising a fourth arrival time when the fourth SDU is estimated to arrive at the modem of the UE after the third arrival time, and the second SDU being different from the fourth SDU.

13. The apparatus of claim 12, wherein the second BSR indicates the second arrival time and the fourth arrival time.

14. The apparatus of claim 12, wherein the second BSR further indicates at least one of a second estimated size of the second SDU based on the at least one first SDU or a fourth estimated size of the fourth SDU based on the third SDU.

15. The apparatus of claim 12, wherein the second SDU and the fourth SDU are associated with different flows.

16. The apparatus of claim 12, wherein the at least one processor is further configured to:
transmit a fourth BSR of the fourth SDU based on the fourth estimation, the fourth BSR being comprised in a second target physical uplink shared channel (PUSCH) to transmit the second SDU based on the second BSR.

17. The apparatus of claim 16, wherein the second BSR indicates a size of the fourth BSR to be comprised in the second target PUSCH.

18. The apparatus of claim 1, wherein the second BSR is transmitted in a physical uplink shared channel (PUSCH) transmitting the at least one first SDU.

19. The apparatus of claim 1, wherein the second BSR of the second SDU is transmitted via an uplink configured grant based on the second SDU not being received at the modem of the UE before the uplink configured grant,
wherein the second SDU is transmitted in a second target physical uplink shared channel (PUSCH) indicated by the second BSR.

20. The apparatus of claim 1, wherein the second BSR of the second SDU comprises an indication of a plurality of target physical uplink shared channels (PUSCHs), and wherein the second SDU is transmitted in at least one of the plurality of target PUSCHs.

21. An apparatus for wireless communication at a network node, comprising:
a memory; and
at least one processor coupled to the memory and, based at least in part on information stored in the memory, the at least one processor is configured to:
receive at least one buffer status report (BSR) indicating at least one target physical uplink shared channel (PUSCH) from a user equipment (UE), the at least one BSR comprising a second BSR based on an estimation of a second service data unit (SDU) comprising a second arrival time of the second SDU at a modem of the UE, the estimation of the second SDU being based on at least one first SDU with a first arrival time at the modem of the UE, the second arrival time being after the first arrival time;
transmit at least one uplink grant of the at least one target PUSCH based on the at least one BSR indicating the at least one target PUSCH; and
receive the second SDU in the at least one target PUSCH.

22. The apparatus of claim 21, wherein the estimation of the second SDU further comprises an estimated size of the second SDU based on a size of the at least one first SDU.

23. The apparatus of claim 21, wherein the at least one processor is further configured to:
transmit a configuration of at least one dedicated configured grant for transmitting the second BSR of the second SDU based on the estimation of the second SDU.

24. The apparatus of claim 21, wherein the BSR indicates a transmission time of the at least one target PUSCH to transmit the second SDU.

25. The apparatus of claim 24, wherein the at least one processor is further configured to:
receive a scheduling request (SR) prior to the second arrival time; and
transmit an uplink grant based on the SR,
wherein the second BSR is received based on the uplink grant prior to the second arrival time.

26. The apparatus of claim 24, wherein the transmission time of the target PUSCH is indicated in reference to the transmission of the BSR.

27. The apparatus of claim 24, wherein the BSR indicates an estimated size of the second SDU based on the at least one first SDU.

28. The apparatus of claim 21, wherein the at least one processor is further configured to:
receive a fourth BSR of a fourth SDU from the UE, the fourth BSR based on an estimation of the fourth SDU comprising a fourth arrival time of the fourth SDU at the modem of the UE,
wherein the estimation of the fourth SDU being based on at least one third SDU with a third arrival time at the modem of the UE, the fourth arrival time is after the third arrival time, and based on the fourth estimation, the fourth BSR is comprised in the at least one target PUSCH a second target PUSCH to transmit the second SDU based on the second BSR, and the second SDU is different from the fourth SDU.

29. A method of wireless communication at a user equipment (UE), comprising:
obtaining an estimation of a second service data unit (SDU) based on at least one first SDU with a first arrival time at a modem of the UE, the estimation of the second SDU comprising a second arrival time at the modem of the UE, the second arrival time being after the first arrival time; and
initiating a transmission of a second buffer status report (BSR) of the second SDU based on the estimation of the second SDU.

30. A method of wireless communication at a network node, comprising:
receiving at least one buffer status report (BSR) indicating at least one target physical uplink shared channel (PUSCH) from a user equipment (UE), the at least one BSR comprising a second BSR based on an estimation of a second service data unit (SDU) comprising a second arrival time of the second SDU at a modem of the UE, the estimation of the second SDU being based on at least one first SDU with a first arrival time at the modem of the UE, the second arrival time being after the first arrival time;
transmitting at least one uplink grant of the at least one target PUSCH based on the at least one BSR indicating the at least one target PUSCH; and
receiving the second SDU in the at least one target PUSCH.
